(19) United States
(12) Patent Application Publication
(10) Pub. No.: US 2025/0023766 A1
(43) Pub. Date: Jan. 16, 2025

(54) METHOD AND DEVICE FOR SIGNAL TRANSMISSION IN A WIRELESS COMMUNICATION SYSTEM

(71) Applicant: Samsung Electronics Co., Ltd., Suwon-si (KR)

(72) Inventors: Qi LI, Beijing (CN); Di SU, Beijing (CN); Bowen YANG, Beijing (CN); Chen QIAN, Beijing (CN)

(21) Appl. No.: 18/647,265

(22) Filed: Apr. 26, 2024

(30) Foreign Application Priority Data
Jul. 14, 2023 (CN) 202310869217.5

(51) Int. Cl. H04L 27/26; H04L 1/00; H04W 8/22; H04W 52/36

(52) U.S. Cl. CPC H04L 27/2618; H04L 1/0003; H04W 8/22; H04W 52/367

(57) ABSTRACT

The disclosure relates to a 5^{th} generation (5G) communication system or a 6^{th} generation (6G) communication system for supporting a higher data rate than a 4^{th} generation (4G) communication system, such as long term evolution (LTE). A method performed by a user equipment (UE) in a wireless communication system is provided. The method includes transmitting a first message to a first network node, wherein the first message indicates whether the UE has a capability related to supporting peak-to-average power ratio (PAPR) processing, or the first message indicates whether the UE has a capability related to supporting tone reservation (TR) technology, receiving a second message transmitted by the first network node, wherein the second message informs the UE to use or not to use TR technology, determining information of reserved tones when using TR technology according to the second message, wherein the information of reserved tones includes at least one of the proportion, number, or position of reserved tones, determining an uplink signal based on the information of reserved tones, and transmitting the uplink signal.

### CROSS-REFERENCE TO RELATED APPLICATION(S)

This application is based on and claims priority under 35 U.S.C. § 119(a) of a Chinese patent application number 202310869217.5, filed on Jul. 14, 2023, in the Chinese Intellectual Property Office, the disclosure of which is incorporated by reference herein in its entirety.

### BACKGROUND

### 1. Field

The disclosure relates to the field of wireless communication. More particularly, the disclosure relates to a method and corresponding device for signal transmission.

### 2. Description of Related Art

5^{th} generation (5G) mobile communication technologies define broad frequency bands such that high transmission rates and new services are possible, and can be implemented not only in “Sub 6 gigahertz (GHz)” bands, such as 3.5 GHz, but also in “Above 6 GHz” bands referred to as millimeter-wave (mmWave) including 28 GHz and 39 GHz. In addition, it has been considered to implement 6^{th} generation (6G) mobile communication technologies (referred to as Beyond 5G systems (5GSs)) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

Considering the development of wireless communication from generation to generation, the technologies have been developed mainly for services targeting humans, such as voice calls, multimedia services, and data services. Following the commercialization of 5th-generation (5G) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6th-generation (6G) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (e.g., 95 GHz to 3THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies, such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems a full-duplex technology for enabling an uplink transmission and a downlink transmission to simultaneously use the same frequency resource at the same time, a network technology for utilizing satellites, high-altitude platform stations (HAPS), and the like in an integrated manner, an improved network structure for supporting mobile base stations and the like and enabling network operation optimization and automation and the like, a dynamic spectrum sharing technology via collision avoidance based on a prediction of spectrum usage, an use of artificial intelligence (AI) in wireless communication for improvement of overall network operation by utilizing AI from a designing phase for developing 6G and internalizing end-to-end AI support functions, and a next-generation distributed computing technology for overcoming the limit of user equipment (UE) computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. More particularly, it is expected that services, such as truly immersive extended reality (XR), high-fidelity mobile hologram, and digital replica could be provided through 6G communication systems. In addition, services, such as remote surgery for security and reliability enhancement, industrial automation, and emergency response will be provided through the 6G communication system such that the technologies could be applied in various fields, such as industry, medical care, automobiles, and home appliances.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and corresponding device for signal transmission.

Additional aspects will be set forth in part in the description which follows and, in part, will be apparent from the description, or may be learned by practice of the presented embodiments.

In accordance with an aspect of the disclosure, a method performed by a user equipment (UE) in a wireless communication system is provided. The method includes transmitting a first message to a first network node, wherein the first message indicates whether the UE has a capability related to supporting peak-to-average power ratio (PAPR) processing, or the first message indicates whether the UE has a capability related to supporting tone reservation (TR) technology, receiving a second message transmitted by the first network node, wherein the second message informs the UE to use or not to use TR technology, determining information of reserved tones when using TR technology according to the second message, wherein the information of reserved tones includes at least one of the proportion, number, or position of reserved tones, determining an uplink signal based on the information of reserved tone, and transmitting the uplink signal.

In various embodiments of the disclosure, the information of reserved tones is determined based on at least one of transmission bandwidth, sub-carrier spacing, modulation and coding scheme (MCS), carrier waveform, power class, or resource block (RB) allocation mode.

In various embodiments of the disclosure, the preparation time for the uplink signal is related to TR preparation time.

In various embodiments of the disclosure, the TR preparation time is related to at least one of transmission bandwidth, sub-carrier spacing, MCS, carrier waveform, power class, or RB allocation mode.

In various embodiments of the disclosure, the transmission power of the uplink signal is determined based on the parameter related to maximum power reduction (MPR).

In various embodiments of the disclosure, the parameter related to MPR is determined based on at least one of transmission bandwidth, sub-carrier spacing, MCS, carrier waveform, power class, or RB allocation mode.

In various embodiments of the disclosure, the parameter related to MPR includes at least one of a second MPR value or a second MPR offset value, wherein the second MPR value or/and the second MPR offset value are related to PAPR processing.

In various embodiments of the disclosure, the first message further includes at least one of a class parameter related to PAPR processing that can be supported by the UE or information about the parameter related to MPR that can be supported by the UE.

In various embodiments of the disclosure, the method further comprises receiving a third message transmitted by the first network node, wherein the third message includes at least one of class parameter indication related to PAPR processing, parameter indication related to MPR, parameter indication related to PAPR processing or parameter indication related to MPR.

In various embodiments of the disclosure, the second message and the third message may be same message.

In various embodiments of the disclosure, the method further comprises receiving a reconfigured third message transmitted by the first network node.

In various embodiments of the disclosure, the method further comprises determining the class parameter related to PAPR processing based on the third message.

In various embodiments of the disclosure, the method further comprises determining parameter related to MPR based on the third message, for uplink signal transmission.

In accordance with another aspect of the disclosure, a method performed by a first network node in a wireless communication system is provided. The method includes receiving a first message from a user equipment (UE), wherein the first message indicates whether the UE has a capability related to supporting PAPR processing, or the first message indicates whether the UE has a capability related to supporting tone reservation (TR) technology, transmitting a second message to the UE, wherein the second message informs the UE to use or not to use TR technology, and receiving an uplink signal from the UE, wherein the uplink signal is determined based on information of reserved tones, wherein the information of reserved tones includes at least one of the proportion, number and position of reserved tones.

In various embodiments of the disclosure, the power of the uplink signal is determined based on parameter related to maximum power reduction (MPR).

In various embodiments of the disclosure, the parameter related to MPR includes at least one of a second MPR value or a second MPR offset value, wherein the second MPR value or/and the second MPR offset value are related to PAPR processing.

In various embodiments of the disclosure, the first message further includes at least one of a class parameter related to PAPR processing that can be supported by the UE or information about the parameter related to MPR that can be supported by the UE.

In various embodiments of the disclosure, the method further comprises transmitting a third message to the UE, wherein the third message includes at least one of class parameter indication related to PAPR processing, parameter indication related to MPR, parameter indication related to PAPR processing or parameter indication related to MPR.

In accordance with another aspect of the disclosure, a user equipment (UE) is provided. The UE includes a transceiver configured to transmit and/or receive signals, memory storing one or more computer programs and one or more processors communicatively coupled to the transceiver and the memory, wherein the one or more computer programs include computer-executable instructions that, when executed by the one or more processors, cause the UE to transmit a first message to a first network node, wherein the first message indicates whether the UE has a capability related to supporting peak-to-average power ratio (PAPR) processing, or the first message indicates whether the UE has a capability related to supporting tone reservation (TR) technology, receive a second message transmitted by the first network node, wherein the second message informs the UE to use or not to use TR technology, determine information of reserved tones when using TR technology according to the second message, wherein the information of reserved tones includes at least one of proportion, number, or position of reserved tones, determine an uplink signal based on the information of reserved tone, and transmit the uplink signal.

In accordance with another aspect of the disclosure, a first network node is provided. The first network node includes a transceiver configured to transmit and/or receive signals, memory storing one or more computer programs, and one or more processors communicatively coupled to the transceiver and the memory, wherein the one or more computer programs include computer-executable instructions that, when executed by the one or more processors, cause the UE to transmit a first message to a first network node, wherein the first message indicates whether the UE has a capability related to supporting peak-to-average power ratio (PAPR) processing, or the first message indicates whether the UE has a capability related to supporting tone reservation (TR) technology, receive a second message transmitted by the first network node, wherein the second message informs the UE to use or not to use TR technology, determine information of reserved tones when using TR technology according to the second message, wherein the information of reserved tones includes at least one of proportion, number, or position of reserved tones, determine an uplink signal based on the information of reserved tone, and transmit the uplink signal.

In accordance with another aspect of the disclosure, one or more non-transitory computer-readable storage media storing computer-executable instructions that, when executed by one or more processors of a user equipment (UE), cause the UE to perform operations are provided. The operations include transmitting a first message to a first network node, wherein the first message indicates whether the UE has a capability related to supporting peak-to-average power ratio (PAPR) processing, or the first message indicates whether the UE has a capability related to supporting tone reservation (TR) technology, receiving a second message transmitted by the first network node, wherein the second message informs the UE to use or not to use TR technology, determining information of reserved tones when using TR technology according to the second message, wherein the information of reserved tones includes at least one of proportion, number, or position of reserved tones, determining an uplink signal based on the information of reserved tone, and transmitting the uplink signal.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a wireless network according to an embodiment of the disclosure;

FIG. 2 illustrates a base station according to an embodiment of the disclosure;

FIG. 3 illustrates a user equipment according to an embodiment of the disclosure;

FIG. 4 illustrates a schematic diagram of a method according to an embodiment of the disclosure;

FIG. 5 illustrates a behavior at terminal side according to an embodiment of the disclosure;

FIG. 6 illustrates a behavior at terminal side according to an embodiment of the disclosure;

FIG. 7 illustrates a behavior at terminal side according to an embodiment of the disclosure;

FIG. 8 illustrates a behavior at terminal side according to an embodiment of the disclosure;

FIGS. 9, 10, and 11 illustrate schematic diagrams of processing approaches when position of reserved tones conflicts with position of a reference signal according to various embodiments of the disclosure;

FIGS. 12, 13, 14, 15, and 16 illustrate schematic diagrams of positions of reserved tones according to various embodiments of the disclosure;

FIG. 17 illustrates a hardware block diagram of a communication device provided according to an embodiment of the disclosure;

FIG. 18 illustrates a hardware block diagram of a user equipment (UE) provided according to an embodiment of the disclosure; and

FIG. 19 illustrates a hardware block diagram of a base station (BS) provided according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Before undertaking the DETAILED DESCRIPTION below, it may be advantageous to set forth definitions of certain words and phrases used throughout this patent document. The term “couple” and its derivatives refer to any direct or indirect communication between two or more elements, whether those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. Likewise, the term “set” means one or more. Accordingly, a set of items can be a single item or a collection of two or more items.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for embodiment in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

In communication systems, multi-carrier technology is, due to its strong capability of anti-multipath interference and high spectrum utilization, widely applied in wireless broadcasting and communication systems, such as orthogonal frequency-division multiplexing (OFDM), universal filtered-OFDM (UF-OFDM), filtered-OFDM (F-OFDM), generalized FDM (GFDM) and filter bank multi-carrier offset-quadrature amplitude modulation (QAM) (FBMC-OQAM), or the like. These multi-carrier technologies have high peak-to-average power ratio (PAPR) since they all adopt the modulation schemes based on Fourier transform. High PAPR forces the signal to work in the linear region of PA at the expense of large power back-off when amplifying the signal power through the power amplifier (PA), to ensure the output quality of the signal. On the one hand, such working mode leads to low energy utilization, because the large power back-off actually improves the linearity of the PA at the sacrifice of direct current (DC) power consumption. As one of the largest energy-consuming devices in wireless communication systems, the energy consumption of the PA accounts for 50%-80% of that of the base stations in cellular networks. However, green and low carbon is the direction indicator of the future development of communication industry, and thus reducing PAPR to improve PA's energy efficiency is of vital significance to reduce the energy consumption of the whole network. On the other hand, when the signal is power amplified utilizing the PA, a large power back-off may limit the output power of the PA, and in turn limit the transmission power of the signal. The limitation of signal transmission power may further limit the coverage of the signal. Therefore, reducing PAPR to improve the transmission power of the signal is also of great significance to improve the coverage of the signal.

In order to reduce the PAPR, some advanced technologies can be adopted to process the data at the transmitter and/or receiver, thereby ensuring the receiving performance of the receiver while reducing the PAPR. For example, tone reservation (TR) technology has good performance of PAPR improvement, and does not require additional processing at the receiving end. However, for a scheme with both fixed number and fixed positions of reserved tones, the number and positions of the reserved tones cannot be flexibly adjusted according to specific application scenarios, which limits the degree of improvement of PAPR and further limits the improvement of performance in different application scenarios after adopting TR technology. With respect to this problem, the disclosure proposes a new signal transmission method that can flexibly configure different proportions and/or numbers and/or positions of reserved tones. Flexible adjustment of spectrum resources and power efficiency can be realized by flexibly configuring the proportion and/or number and/or position of reserved tones, which is fully applicable for different application scenarios. For example, in a scenario with abundant bandwidth resources but also with coverage improvement requirements, more reserved tones may be adopted to reduce PAPR, so as to improve transmission power and further improve coverage, for a scenario with abundant bandwidth resources but with limited power, more reserved tones may also be adopted to reduce PAPR, so as to improve power utilization and save power. However, for a scenario without coverage improvement requirements and/or with sufficient power but with improvement requirements for spectrum utilization, the number of reserved tones may be reduced to improve frequency utilization. Such approach of flexible configuration is especially applicable for millimeter wave communication and terahertz communication with extremely abundant spectrum resources.

It can be understood that, throughout the description of the disclosure, the tone reservation (TR) technique is adopted as an example of a technique for reducing or adjusting PAPR of a signal. It can be understood that, the techniques and principles of the disclosure can also be applied to other techniques for reducing or adjusting PAPR of a signal. Moreover, in the disclosure, expressions, such as “PAPR reduction” and “reducing PAPR” or the like are used for convenience of description and for avoidance of redundancy. It can be understood that, the principles of the disclosure described in conjunction with such expressions can also be applied to other various processing or adjustments for PAPR, and are not limited merely to such form of adjustment of PAPR reduction. In addition, “TR technology parameter(s)” mentioned in the disclosure refer to the parameter(s) involved in operations related to TR. In addition, “terminal” described throughout the description can be used interchangeably with “user equipment”, “UE”, “mobile station”, “subscriber” and so on.

The figures included herein, and the various embodiments used to describe the principles of the disclosure are by way of illustration only and should not be construed in any way to limit the scope of the disclosure. Further, those skilled in the art will understand that the principles of the disclosure may be implemented in any suitably arranged wireless communication system.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

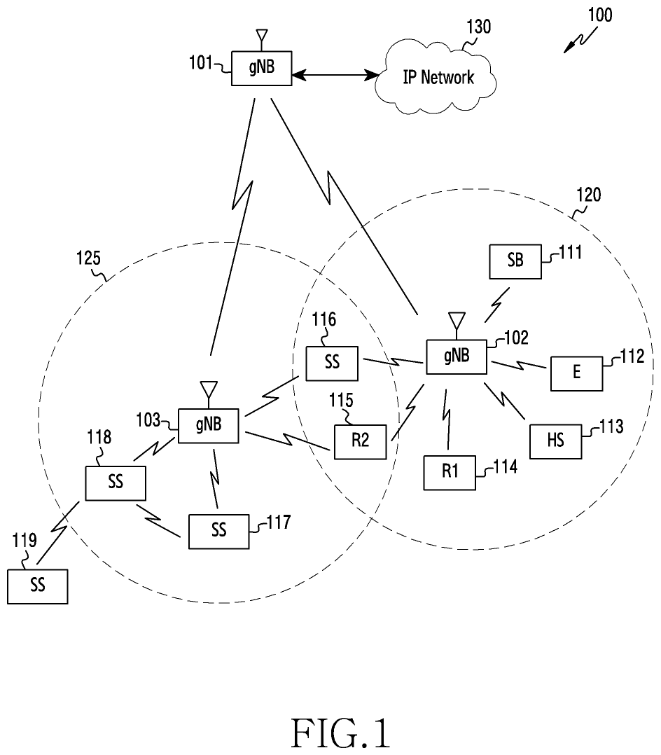

FIGS. 1 to 19 below describe various embodiments of the disclosure implemented in wireless communications systems. The descriptions of FIGS. 1 to 19 are not meant to imply physical or architectural limitations to the manner in which different embodiments may be implemented. Different embodiments of the disclosure may be implemented in any suitably-arranged communications system.

FIG. 1 illustrates a wireless network according to an embodiment of the disclosure.

Referring to FIG. 1, the embodiment of the wireless network shown in FIG. 1 is for illustration only. Other embodiments of a wireless network 100 could be used without departing from the scope of the disclosure.

As shown in FIG. 1, the wireless network includes a base station (next generation nodeB, gNB or gNodeB) 101, a gNB 102, and a gNB 103. The gNB 101 communicates with the gNB 102 and the gNB 103. The gNB 101 also communicates with at least one network 130, such as the Internet, a proprietary Internet protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business, a UE 112, which may be located in an enterprise (E); a UE 113, which may be located in a Wi-Fi hotspot (HS), a UE 114, which may be located in a first residence (R1), a UE 115, which may be located in a second residence (R2), and a UE 116, which may be a mobile device (M), such as a cell phone, a wireless laptop, a wireless personal digital assistant (PDA), or the like. The gNB 103 provides wireless broadband access to the network 130 for a second plurality of UEs within a coverage area 125 of the gNB 103. The second plurality of UEs includes the UE 115 and the UE 116, as well as subscriber stations (SS, for example, UEs) 117, 118 and 119. In some embodiments of the disclosure, one or more of the gNBs 101-103 may communicate with each other and with the UEs 111-116 using existing wireless communication techniques, and one or more of the UE 111-119 may communicate directly with each other (e.g., UEs 117-119) using other existing or proposed wireless communication techniques.

Depending on the network type, the term “base station” or “BS” can refer to any component (or collection of components) configured to provide wireless access to a network, such as transmit point (TP), transmit-receive point (TRP), an enhanced (or “evolved”) base station (eNodeB or eNB), a 5G base station (gNB), a macrocell, a femtocell, a wireless fidelity (Wi-Fi) access point (AP), or other wirelessly enabled devices. Base stations may provide wireless access in accordance with one or more wireless communication protocols, e.g., 3^{rd} generation partnership project (3GPP) 5G new radio (NR), long term evolution (LTE), LTE advanced (LTE-A), high speed packet access (HSPA), Wi-Fi 802.11a/b/g/n/ac, or the like. For the sake of convenience, the various names for a base station-type apparatus and functionality are used interchangeably in this patent document to refer to network infrastructure components that provide wireless access to remote terminals. In addition, depending on the network type, the term “user equipment” (UE) can refer to any component, such as a mobile station (MS), subscriber station (SS), remote terminal, wireless terminal, receive point, or user device. For the sake of convenience, the various names for a user equipment-type device and functionality are used interchangeably in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described below, one or more of the UEs 111-119 include circuitry, programing, or a combination thereof. In certain embodiments of the disclosure, and one or more of the gNBs 101-103 includes circuitry, programing, or a combination thereof.

Although FIG. 1 illustrates one example of a wireless network, various changes may be made to FIG. 1. For example, the wireless network could include any number of gNBs and any number of UEs in any suitable arrangement. In addition, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

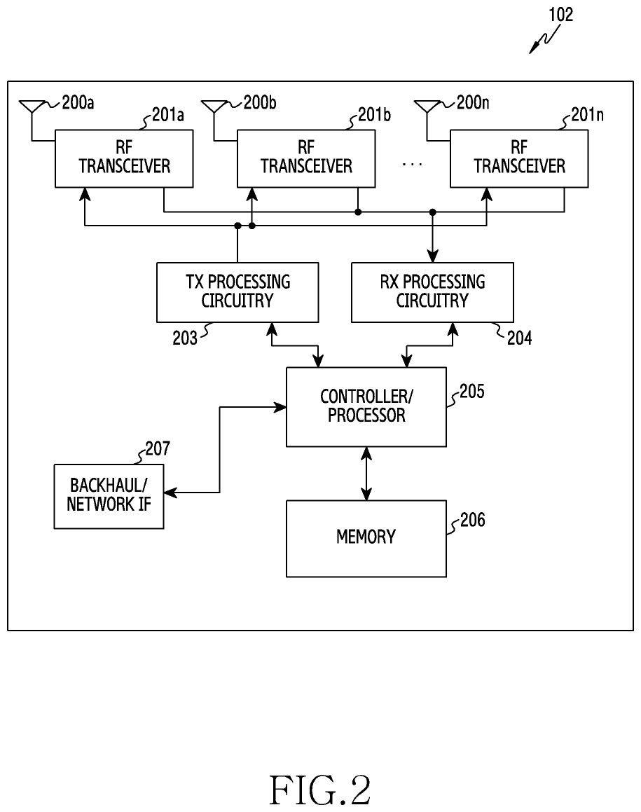

FIG. 2 illustrates a base station according to an embodiment of the disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the disclosure to any particular embodiment of a gNB.

Referring to FIG. 2, the gNB 102 includes multiple antennas 200a-200n, multiple radio frequency (RF) transceivers 201a-201n, transmit (TX) processing circuitry 203, and receive (RX) processing circuitry 204. The gNB 102 also includes a controller/processor 205, memory 206, and a backhaul or network interface 207.

The RF transceivers 201a-201n receive, from the antennas 200a-200n, incoming RF signals, such as signals transmitted by UEs in the wireless network 100. The RF transceivers 201a-201n down-convert the incoming RF signals to generate intermediate frequency (IF) or baseband signals. The IF or baseband signals are sent to the RX processing circuitry 204, which generates processed baseband signals by filtering, decoding, and/or digitizing the baseband or IF signals. The RX processing circuitry 204 transmits the processed baseband signals to the controller/processor 205 for further processing.

The TX processing circuitry 203 receives analog or digital data (such as voice data, web data, electronic mail, or interactive video game data) from the controller/processor 205. The TX processing circuitry 203 encodes, multiplexes, and/or digitizes the outgoing baseband data to generate processed baseband or IF signals. The RF transceivers 201a-201n receive the outgoing processed baseband or IF signals from the TX processing circuitry 203 and up-converts the baseband or IF signals to RF signals that are transmitted via the antennas 201a-201n.

The controller/processor 205 can include one or more processors or other processing devices that control the overall operation of the gNB 102. For example, the controller/processor 205 could control the reception of forward channel signals and the transmission of reverse channel signals by the RF transceivers 201a-201n, the RX processing circuitry 204, and the TX processing circuitry 203 in accordance with well-known principles. The controller/processor 205 could support additional functions as well, such as more advanced wireless communication functions.

For instance, the controller/processor 205 could support beam forming or directional routing operations in which outgoing signals from multiple antennas 200a-200n are weighted differently to effectively steer the outgoing signals in a desired direction. Any of a wide variety of other functions could be supported in the gNB 102 by the controller/processor 205.

The controller/processor 205 is also capable of executing programs and other processes resident in the memory 206, such as an operating system (OS). The controller/processor 205 can move data into or out of the memory 206 as required by an executing process.

The controller/processor 205 is also coupled to the backhaul or network interface 207. The backhaul or network interface 207 allows the gNB 102 to communicate with other devices or systems over a backhaul connection or over a network. The network interface 207 could support communications over any suitable wired or wireless connection(s). For example, when the gNB 102 is implemented as part of a cellular communication system (such as one supporting 5G, LTE, or LTE-A), the network interface 207 could allow the gNB 102 to communicate with other gNBs over a wired or wireless backhaul connection. When the gNB 102 is implemented as an access point, the network interface 207 could allow the gNB 102 to communicate over a wired or wireless local area network or over a wired or wireless connection to a larger network (such as the Internet). The network interface 207 includes any suitable structure supporting communications over a wired or wireless connection, such as an Ethernet or RF transceiver.

The memory 206 is coupled to the controller/processor 205. Part of the memory 206 could include random access memory (RAM), and another part of the memory 206 could include flash memory or other read only memory (ROM).

Although FIG. 2 illustrates one example of the gNB 102, various changes may be made to FIG. 2. For example, the gNB 102 could include any number of each component shown in FIG. 2. As a particular example, an access point could include a number of network interfaces 207, and the controller/processor 205 could support routing functions to route data between different network addresses. As another particular example, while shown as including a single instance of TX processing circuitry 203 and a single instance of RX processing circuitry 204, the gNB 102 could include multiple instances of each (such as one per RF transceiver). In addition, various components in FIG. 2 could be combined, further subdivided, or omitted and additional components could be added according to particular needs.

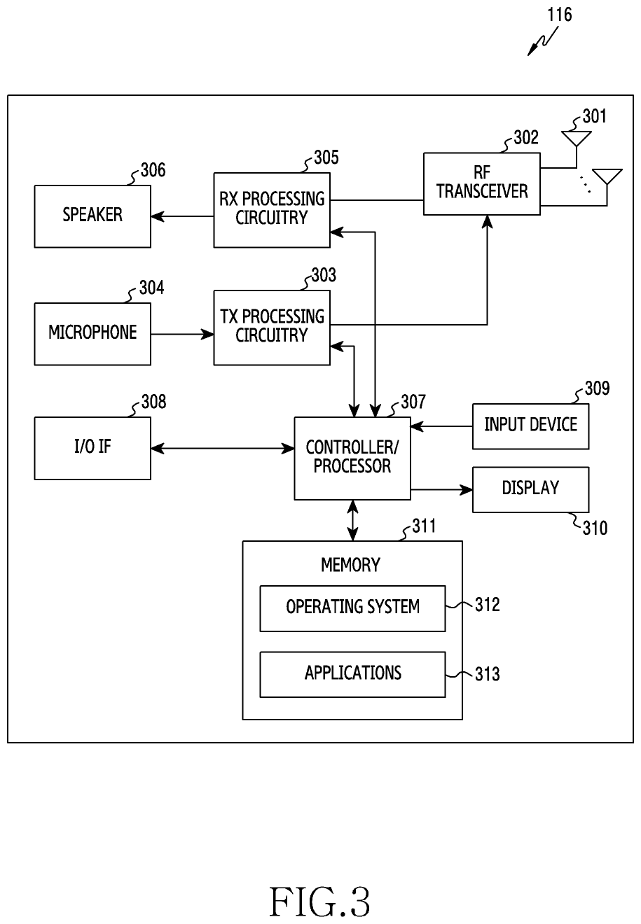

FIG. 3 illustrates a user equipment according to an embodiment of the disclosure. The embodiment of the UE 116 illustrated in FIG. 3 is for illustration only, and the UEs 111-115 and 117-119 of FIG. 1 could have the same or similar configuration. However, UEs come in a wide variety of configurations, and FIG. 3 does not limit the scope of the disclosure to any particular embodiment of a UE.

Referring to FIG. 3, the UE 116 includes an antenna 301, a radio frequency (RF) transceiver 302, TX processing circuitry 303, a microphone 304, and receive (RX) processing circuitry 305. The UE 116 also includes a speaker 306, a controller/processor 307, an input/output (I/O) interface (IF) 308, an input device 309, a touchscreen display 310, and memory 311. The memory 311 includes an OS 312 and one or more applications 313.

The RF transceiver 302 receives, from the antenna 301, an incoming RF signal transmitted by a gNB of the wireless network 100. The RF transceiver 302 down-converts the incoming RF signal to generate an IF or baseband signal. The IF or baseband signal is sent to the RX processing circuitry 305, which generates a processed baseband signal by filtering, decoding, and/or digitizing the baseband or IF signal. The RX processing circuitry 305 transmits the processed baseband signal to the speaker 306 (such as for voice data) or to the processor 307 for further processing (such as for web browsing data).

The TX processing circuitry 303 receives analog or digital voice data from the microphone 304 or other outgoing baseband data (such as web data, e-mail, or interactive video game data) from the processor 307. The TX processing circuitry 303 encodes, multiplexes, and/or digitizes the outgoing baseband data to generate a processed baseband or IF signal. The RF transceiver 302 receives the outgoing processed baseband or IF signal from the TX processing circuitry 303 and up-converts the baseband or IF signal to an RF signal that is transmitted via the antenna 301.

The processor 307 can include one or more processors or other processing devices and execute the OS 312 stored in the memory 311 in order to control the overall operation of the UE 116. For example, the processor 307 could control the reception of forward channel signals and the transmission of reverse channel signals by the RF transceiver 302, the RX processing circuitry 305, and the TX processing circuitry 303 in accordance with well-known principles. In some embodiments of the disclosure, the processor 307 includes at least one microprocessor or a microcontroller.

The processor 307 is also capable of executing other processes and programs resident in the memory 311, such as processes for channel state information (CSI) reporting on uplink channel. The processor 307 can move data into or out of the memory 311 as required by an executing process. In some embodiments of the disclosure, the processor 307 is configured to execute the applications 313 based on the OS 312 or in response to signals received from gNBs or an operator. The processor 307 is also coupled to the I/O interface 308, which provides the UE 116 with the ability to connect to other devices, such as laptop computers and handheld computers. The I/O interface 308 is the communication path between these accessories and the processor 307.

The processor 307 is also coupled to the touchscreen display 310. The user of the UE 116 can use the touchscreen display 310 to enter data into the UE 116. The touchscreen display 310 may be a liquid crystal display, light emitting diode display, or other display capable of rendering text and/or at least limited graphics, such as from web sites.

The memory 311 is coupled to the processor 307. Part of the memory 311 could include RAM, and another part of the memory 311 could include flash memory or other ROM.

Although FIG. 3 illustrates one example of UE 116, various changes may be made to FIG. 3. For example, various components in FIG. 3 could be combined, further subdivided, or omitted and additional components could be added according to particular needs. As a particular example, the processor 307 could be divided into multiple processors, such as one or more central processing units (CPUs) and one or more graphics processing units (GPUs). In addition, while FIG. 3 illustrates the UE 116 configured as a mobile telephone or smartphone, UEs could be configured to operate as other types of mobile or stationary devices.

According to at least one embodiment of the disclosure, there is provided a method performed by user equipment (UE) in a wireless communication system, comprising: transmitting a first message to a first network node, wherein the first message indicates whether the UE has a capability related to supporting PAPR processing, or the first message indicates whether the UE has a capability related to supporting tone reservation (TR) technology; receiving a second message transmitted by the first network node, wherein the second message informs the UE to use or not to use TR technology; determining information of reserved tones when using TR technology according to the second message, wherein the information of reserved tones includes at least one of the proportion, number and position of reserved tones; determining an uplink signal based on the information of reserved tone; transmitting the uplink signal.

In various embodiments of the disclosure, the information of reserved tones is determined based on at least one of the following information: transmission bandwidth, sub-carrier spacing, modulation and coding scheme (MCS), carrier waveform, power class, and resource block (RB) allocation mode.

In various embodiments of the disclosure, the preparation time for the uplink signal is related to TR preparation time.

In various embodiments of the disclosure, the TR preparation time is related to at least one of the following information: transmission bandwidth, sub-carrier spacing, MCS, carrier waveform, power class and RB allocation mode.

In various embodiments of the disclosure, the transmission power of the uplink signal is determined based on parameter related to maximum power reduction (MPR).

In various embodiments of the disclosure, the parameter related to MPR is determined based on at least one of the following information: transmission bandwidth, sub-carrier spacing, MCS, carrier waveform, power class and RB allocation mode.

In various embodiments of the disclosure, the parameter related to MPR includes at least one of: a second MPR value and a second MPR offset value, wherein the second MPR value or/and the second MPR offset value are related to PAPR processing.

In various embodiments of the disclosure, the first message further includes at least one of a class parameter related to PAPR processing that can be supported by the UE and information about the parameter related to MPR that can be supported by the UE.

In various embodiments of the disclosure, the method further comprises: receiving a third message transmitted by the first network node, wherein the third message includes at least one of: class parameter indication related to PAPR processing, class parameter indication related to MPR, parameter indication related to PAPR processing and parameter indication related to MPR.

In various embodiments of the disclosure, the second message and the third message may be the same message.

In various embodiments of the disclosure, the method further comprises: receiving a reconfigured third message transmitted by the first network node.

In various embodiments of the disclosure, the method further comprises: determining the class parameter related to PAPR processing based on the third message.

In various embodiments of the disclosure, the method further comprises determining the parameter related to MPR based on the third message, for uplink signal transmission.

According to at least one embodiment of the disclosure, there is provided a method performed by a first network node in a wireless communication system, including receiving a first message from a user equipment (UE), wherein the first message indicates whether the UE has a capability related to supporting PAPR processing, or the first message indicates whether the UE has a capability related to supporting tone reservation (TR) technology, transmitting a second message to the UE, wherein the second message informs the UE to use or not to use TR technology, receiving an uplink signal from the UE, wherein the uplink signal is determined based on information of reserved tones, wherein the information of reserved tones includes at least one of the proportion, number, or position of reserved tones.

In various embodiments of the disclosure, the power of the uplink signal is determined based on parameter related to maximum power reduction (MPR).

In various embodiments of the disclosure, the parameter related to MPR includes at least one of a second MPR value and a second MPR offset value, wherein the second MPR value or/and the second MPR offset value are related to PAPR processing.

In various embodiments of the disclosure, the first message further includes at least one of a class parameter related to PAPR processing that can be supported by the UE or information about a parameter related to MPR that can be supported by the UE.

In various embodiments of the disclosure, the method further comprises transmitting a third message to the UE, wherein the third message includes at least one of class parameter indication related to PAPR processing, parameter indication related to MPR, parameter indication related to PAPR processing and parameter indication related to MPR.

According to at least one embodiment of the disclosure, there is provided a user equipment (UE),including a transceiver configured to transmit and/or receive signals, memory storing one or more computer programs, and one or more processors communicatively coupled to the transceiver and the memory, wherein the one or more computer programs include computer-executable instructions that, when executed by the one or more processors, cause the UE to transmit a first message to a first network node, wherein the first message indicates whether the UE has a capability related to supporting peak-to-average power ratio (PAPR) processing, or the first message indicates whether the UE has a capability related to supporting tone reservation (TR) technology, receive a second message transmitted by the first network node, wherein the second message informs the UE to use or not to use TR technology, determine information of reserved tones when using TR technology according to the second message, wherein the information of reserved tones includes at least one of proportion, number, or position of reserved tones, determine an uplink signal based on the information of reserved tone, and transmit the uplink signal.

According to at least one embodiment of the disclosure, there is provided a first network node, a transceiver configured to transmit and/or receive signals, memory storing one or more computer programs, and one or more processors communicatively coupled to the transceiver and the memory, wherein the one or more computer programs include computer-executable instructions that, when executed by the one or more processors, cause the first network node to transmit a first message to a first network node, wherein the first message indicates whether the UE has a capability related to supporting peak-to-average power ratio (PAPR) processing, or the first message indicates whether the UE has a capability related to supporting tone reservation (TR) technology, receive a second message transmitted by the first network node, wherein the second message informs the UE to use or not to use TR technology, determine information of reserved tones when using TR technology according to the second message, wherein the information of reserved tones includes at least one of proportion, number, or position of reserved tones, determine an uplink signal based on the information of reserved tone, and transmit the uplink signal.

According to one embodiment of the disclosure, there is provided a method of uplink signal transmission in a wireless communication system, which processes PAPR of time domain data signals so as to improve the transmission power of the signals. Specifically, TR technology is used to reduce PAPR. In various embodiments of the disclosure, the number and/or positions of the reserved tones are selected according to specific application conditions to realize the TR technology, so as to flexibly adjust the degree of PAPR reduction of time-domain data signals; further, after the signal's PAPR is reduced, the maximum output power reduction (MPR) value would change accordingly, the power back-off of PA can be reduced, the transmission power of the corresponding signal can be increased, and meanwhile, the working efficiency of PA can be improved. The flexible adjustment of spectrum resources and coverage and/or power efficiency can be realized by adopting the method proposed in the disclosure.

Wherein, the reserved tones are ones retained in advance on frequency domain for PAPR reduction of time domain signals. Specifically, the reserved tones on frequency domain are not used to transmit data information, and the signals transmitted by them are used to reduce the PAPR of the data information after converting from frequency domain signals to time domain signals.

Embodiments of the disclosure will be described below with reference to the accompanying drawings.

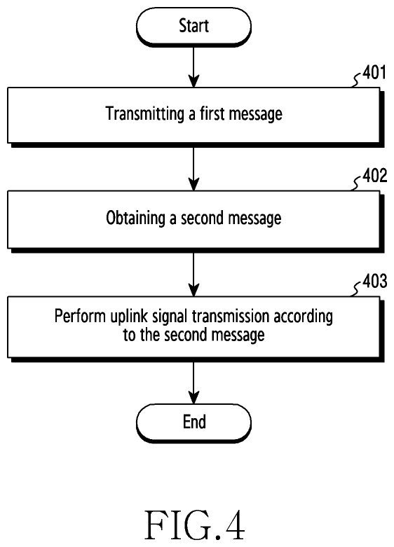

FIG. 4 illustrates a schematic diagram of a method according to an embodiment of the disclosure.

Referring to FIG. 4, the method comprises the following operations:

Operation 401: The UE may transmit a first message to a first network node, wherein the first message indicates whether the UE has a capability related to supporting PAPR processing. For example, in various embodiments of the disclosure, the first message may indicate whether the UE has a capability related to supporting TR technology.

Operation 402: The UE may obtain second information, wherein the second information indicates that the UE uses or does not use TR technology. In various embodiments of the disclosure, the second information is included in a second message.

Operation 403: The UE transmits an uplink signal according to the second information.

It can be understood that the above operations 401 and 402 may be optional operations. In various embodiments of the disclosure, the second information in operation 403 may be preset, or may be obtained according to the second message received from the first network node. The approach of presetting the second information is applicable for scenarios where TR technology is used or not used by default, the second information being obtained based on the second message received from the first network node, is applicable for scenarios where the first network node configures the UE to work in different modes according to specific conditions.

In various embodiments of the disclosure, when the UE uses TR technology according to the second information, the UE may determine information of reserved tones, wherein the information of reserved tones includes proportion and/or number and/or position of the reserved tones. Based on the information of reserved tone, the UE performs TR technology to reduce PAPR. The UE determines the information of reserved tones based on at least one of the following information transmission bandwidth, sub-carrier spacing, modulation and coding scheme (MCS), carrier waveform, power class and RB allocation mode. Wherein, the MCS may be used to indicate the modulation mode, the power class may take a value of, e.g., 1, 1.5, 2, 3, or the like, the carrier waveform may be discrete Fourier transform (DFT)-spread (s)-OFDM and cyclic-prefix (CP)-OFDM, the modulation modes may be Pi/2 binary phase-shift keying (BPSK), quadrature phase-shift keying (QPSK), 16 QAM, 64 QAM, 256 QAM, 1024 QAM and other modulation modes, the RB allocation modes may be edge RB allocation, outer RB allocation and inner RB allocation, the sub-carrier spacing factor μ may take a value of 0, 1, 2, 3, 4, or the like, corresponding to sub-carrier spacing of 15 kHz, 30 kHz, 60 kHz, 120 kHz, 240 kHz, or the like, respectively; the value of channel bandwidth may be 100 MHz, 200 MHz, 400 MHz, 800 MHz, 1600 MHz, 2000 MHz, or the like. The specific embodiment of UE determining information of reserved tones may be to obtain the information of reserved tones according to a set of reserved tone information determination conditions. Wherein, the set of reserved tone information determination conditions may be that the transmission bandwidth and/or sub-carrier spacing and/or MCS and/or carrier waveform and/or power class and/or RB allocation mode are the specific values or specific embodiments as described above. The corresponding PAPR reduction requirements may be obtained according to the set of reserved tone information determination conditions.

In various embodiments of the disclosure, a specific embodiment of the information of reserved tones may be that, corresponding to the set of reserved tone information determination conditions, the number of reserved tones is a, and the positions of reserved tones are represented by a tone index set {A1, A2, . . . , Aa}. Another specific embodiment of the information of reserved tones may be that, corresponding to the set of reserved tone information determination conditions, the proportion of reserved tones is R, and the total number of tones may be determined according to transmission bandwidth and sub-carrier spacing, and by combining the total number of tones with the proportion of reserved tones R, the number of reserved tones may be obtained as a, and the positions of corresponding reserved tones are represented by a tone index set {A1,A2, . . . , Aa}. The method of using reserved tone indexes is simple and clear.

In various embodiments of the disclosure, a specific embodiment of the information of reserved tones may be represented by an equation, wherein the proportion and/or number and/or position of reserved tones are represented as a result of a calculation formula for transmission bandwidth and/or sub-carrier spacing and/or MCS and/or carrier waveform and/or power class and/or RB allocation mode.

For example, as shown in the following formula:

{Nptone, Pindex}=f(B, SCS, M, Wave, Pclass, RBalloc)

or

{Rptone, Pindex}=f(B, SCS, M, Wave, Pclass, Rballoc),
or, Pindex may be determined by f(B, SCS, M, Wave, Pclass, Rballoc), and Nptone or Rptone may be obtained according to Pindex.

Where
f: represents calculation formula;
B: transmission bandwidth;
SCS: subcarrier spacing;
M: MCS;
Wave: carrier waveform;
Pclass: power class;
Rballoc: RB allocation mode;
Rptone: proportion of reserved tones;
Nptone: number of reserved tones;
Pindex: reserved tone index.

For example, the number and indexes of reserved tones are the results of a calculation formula of transmission bandwidth, sub-carrier spacing, MCS, carrier waveform, power class and RB allocation mode, or, the proportion and indexes of reserved tones are the results of a calculation formula of transmission bandwidth, sub-carrier spacing, MCS, carrier waveform, power class and RB allocation mode, or, the number of reserved tones is the result of a calculation formula of transmission bandwidth, sub-carrier spacing, MCS, carrier waveform, power class and RB allocation mode. Avoiding looking up a table by using formula representations, memory resources can be saved.

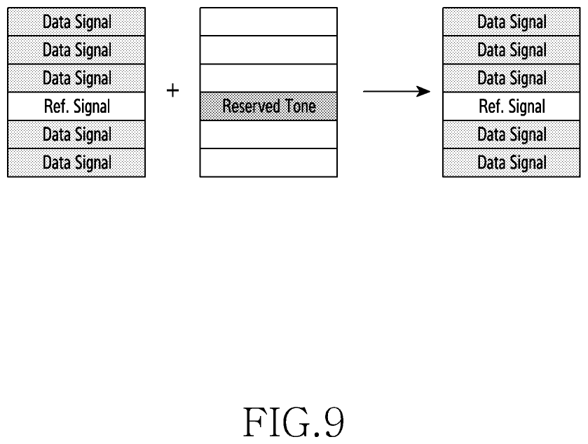

FIGS. 9, 10, and 11 illustrate schematic diagrams of processing approaches when position of reserved tones conflicts with position of a reference signal according to various embodiments of the disclosure.

Referring to FIGS. 9, 10, and 11, the position of the reserved tone index is possible to be occupied by a reference signal, wherein the reference signal include, but are not limited to, demodulation reference signal (DMRS), sounding reference signal (SRS), phase-tracking reference signal (PTRS), and so on. When the reserved tone conflicts with the reference signal, a specific embodiment of the processing approach for the conflict may be that this position belongs to the reference signal, and the reserved tone is absent at this position without additional processing, as shown in FIG. 9. This processing approach is applicable for scenarios where there are a large number of reserved tones and one more or one less reserved tone has little influence on the performance of TR technology.

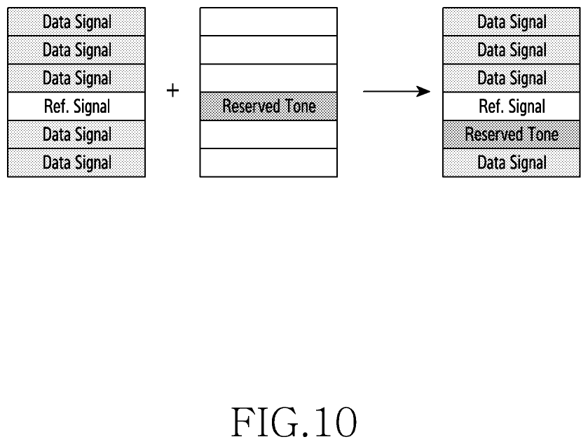

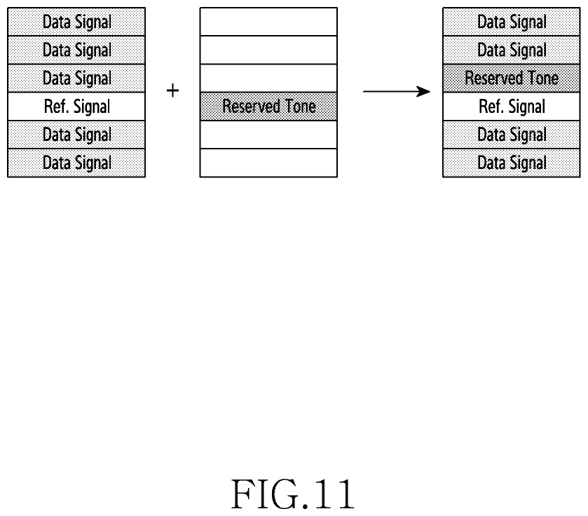

In various embodiments of the disclosure, when the position of the reserved tone index conflicts with the reference signal, a specific embodiment of the processing approach for the conflict may also be that this position belongs to the reference signal, the reserved tone is absent at this position, and the reserved tone occupies a tone position adjacent to this position, wherein the adjacent tone position may be immediately adjacent to the conflicting position, and its specific position may be a position of the index number minus one or a position of the index number plus one, as shown in FIG. 10 or 11. This processing approach is applicable for scenarios where the number of reserved tones is small and it is required to retain enough reserved tone waveforms on frequency domain.

The specific allocation modes of positions of reserved tones on frequency domain include, but are not limited to, one of the following several modes: random allocation, equidistant allocation and continuous allocation. The random allocation of positions of reserved tones on frequency domain refers to that the position of the reserved tone indexes on frequency domain are unconstrained, as long as the reserved tones can meet the PAPR reduction requirements. Such position allocation mode is very flexible and can achieve an allocation mode in which reserved tones correspond to optimal time domain waveforms.

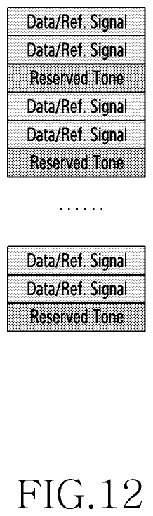

FIGS. 12, 13, 14, 15, and 16 illustrate schematic diagrams of positions of reserved tones according to various embodiments of the disclosure.

Referring to FIGS. 12, 13, 14, 15, and 16, the equidistant allocation of positions of reserved tones on frequency domain refers to that reserved tones are distributed on frequency domain with intervals of an equal number of tones, and meanwhile, it is required to meet the corresponding PAPR reduction requirements. One of the specific embodiments can be shown in FIG. 12. Wherein, the index number set of the positions of reserved tones is

$${P}_{w} = \{ ⌊ \frac{N}{W} ⌋ - 1 + δ , 2 * ⌊ \frac{N}{W} ⌋ - 1 + δ , … , W * ⌊ \frac{N}{W} ⌋ - 1 + δ \}$$

where
N: number of frequency domain tones;
W: number of reserved tones;
δ: starting offset position of reserved tones.

And the index number set meets P_{w}∈{0,1, . . . , N−1}, that is, the index number set is within the bandwidth of frequency domain. Such approach of placing reserved tones with equal intervals can make the reserved tones uniformly distributed, which is convenient for finding and calculating the tone index number.

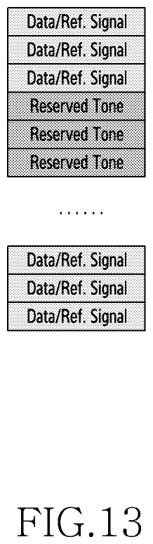

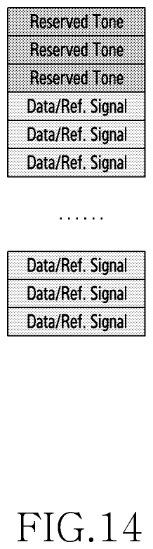

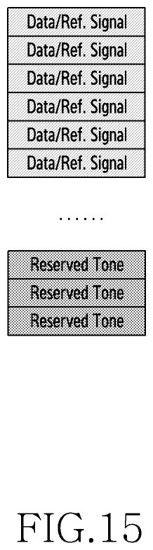

The continuous allocation of reserved tones on frequency domain refers to that the reserved tones are concentrated on a segment of tones on frequency domain resources, and meanwhile, meet the corresponding PAPR reduction requirements. One of the specific embodiments can be shown in FIG. 13, 14, or 15, in which the reserved tones are located in any segment of continuous tones on the frequency domain tones, and the any segment refers to any segment that may be located within the frequency domain tones, as shown in FIG. 13, or any segment that may be located on the upper edge or lower edge of the frequency domain tones, as shown in FIG. 14 or 15. Wherein, the index number set of reserved tones is

$${P}_{w} = \{ δ , δ + 1 , … , δ + W - 1 \}$$

where
W: the number of reserved tones;
δ: starting offset position of reserved tones.

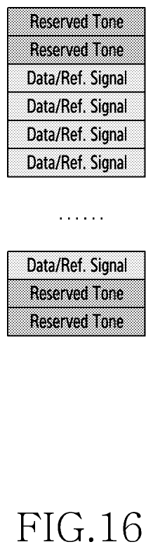

And the index number set meets P_{w}∈{0,1, . . . , N−1}. In addition, the specific embodiment of the continuous allocation may also be a distribution on both the upper and lower edges of the frequency domain tones, as shown in FIG. 16. Wherein, the index number set of reserved tones is

$${P}_{w} = \{ 0 , 1 , … , ⌊ \frac{W}{2} ⌋ - 1 , N + ⌊ \frac{W}{2} ⌋ - W , … , N - 1 \}$$

where
W: the number of reserved tones.

Such approach of continuously placing tones is simple and easy to implement.

In various embodiments of the disclosure, the specific embodiment of placing the reserved tones on frequency domain may also be to place in a spectral mask. Wherein, the spectrum mask is located outside the effective spectrum, and utilizing the spectrum mask to transmit signals to eliminate the time domain peak of the effective data signal may not occupy the effective data bandwidth. Wherein, the specific approach of placing the reserved tones on the spectrum mask further include, but is not limited to, one of the following several approaches: random allocation, equidistant allocation and continuous allocation. It is only required to enable these reserved tones to meet the PAPR reduction requirements. Wherein, the specific allocation modes of random allocation, equidistant allocation and continuous allocation have been defined above, and will not be detailed here.

In various embodiments of the disclosure, generating uplink signal based on the information of reserved tone is required to satisfy TR preparation time. The UE determines the TR preparation time based on at least one of the following information: transmission bandwidth, sub-carrier spacing, MCS, carrier waveform, power class and RB allocation mode. Wherein, the specific meanings and example values of the transmission bandwidth, sub-carrier spacing, MCS, carrier waveform, power class, and RB allocation mode have been defined above, and will not be detailed here. The specific embodiment for UE determining the TR preparation time may be to obtain the TR preparation time according to a set of TR preparation time determination conditions. Wherein, the set of TR preparation time determination conditions may be that the transmission bandwidth and/or sub-carrier spacing and/or MCS and/or carrier waveform and/or power class and/or RB allocation mode are corresponding specific values or specific embodiments. The set of TR preparation time determination conditions may correspondingly identify the PAPR reduction requirements under the conditions.

More particularly, the set of reserved tone information determination conditions and the set of TR preparation time determination conditions may be the same conditions.

One of the specific embodiments of the TR preparation time may be the number of symbols given the corresponding sub-carrier spacing. For the same TR preparation time (e.g., in nanoseconds), different sub-carrier spacings correspond to different numbers of symbols. For example, a specific embodiment of TR preparation time under a corresponding certain set of TR preparation time determination conditions may be as shown in Table 1.

TABLE 1
TR preparation time under a corresponding certain set of
TR preparation time determination conditions

| μ | TR preparation time [number of symbols] |
|---|---|
| 0 | TR0 |
| 1 | TR1 |
| 2 | TR2 |
| 3 | TR3 |
| . . . | . . . |

where μ is the sub-carrier spacing factor, and each value of μ corresponds to a sub-carrier spacing. Corresponding to a certain set of TR preparation time determination conditions, the TR preparation time may be determined (e.g., in nanoseconds), and the specific representative form of TR preparation time is the number of symbols corresponding to the current sub-carrier spacing. For example, a TR preparation time corresponding to a certain set of TR preparation time determination conditions is TR0 number of symbols when μ is 0; and is TR1 number of symbols when μ is 1. In addition, the number of time units with other granularity corresponding to the TR preparation time may also be determined, such as the number of sampling points and the number of time slots.

Correspondingly, after receiving a downlink control information (DCI) scheduling request, the preparation time for the UE to transmit a signal on uplink shared channel (PUSCH) is:

$${T}_{p r o c , 2} = max ( ( ( {N}_{2} + T + {d}_{2 , 1} + {d}_{2 , 2} ) ( 2048 + 144 ) \cdot κ {2}^{- μ} ) \cdot {T}_{c} , {d}_{2 , 3} )$$

where
N₂: time parameter related to processing capacity of UE;
T: TR preparation time;
d_{2,1}: time parameter related to DMRS allocation;
d_{2,2}: time parameter related to hybrid automatic repeat request;
κ: a constant, which is 64;
μ: sub-carrier spacing factor;
T_{c}: minimum sampling interval of OFDM symbols.

By introducing TR preparation time into the calculation of the preparation time for uplink shared channel, the accuracy of the preparation time for uplink shared channel can be improved.

When the UE performs uplink signal transmission, the calculation of signal transmission power may be based on a parameter related to MPR. The parameter related to MPR include at least one of: a second MPR value and a second MPR offset value, wherein the second MPR value or/and the second MPR offset value are related to PAPR processing. The UE determines the parameter related to MPR based on at least one of the following information: MCS, channel bandwidth setting, sub-carrier spacing, carrier waveform, power class and RB allocation mode. Wherein, the MCS may be used to indicate the modulation mode. The specific meanings and values of the transmission bandwidth, sub-carrier spacing, MCS, carrier waveform, power class and RB allocation mode have been defined above, and will not be detailed here. The specific embodiment for UE determining the parameter related to MPR may be to obtain the parameter related to MPR according to a set of determination conditions of parameter related to MPR. Wherein, the set of determination conditions of parameter related to MPR may be that the transmission bandwidth and/or sub-carrier spacing and/or MCS and/or carrier waveform and/or power class and/or RB allocation mode are corresponding specific values or specific embodiments. The set of determination conditions of the parameter related to MPR may correspondingly identify the transmission power requirements under the conditions.

In an example, a specific embodiment of the parameter related to MPR is shown in Table 2 or Table 3. The UE determines the second MPR value or the second MPR offset value according to a combination of carrier waveform, modulation mode, sub-carrier spacing, RB allocation mode, power class and channel bandwidth setting. For example, when the power class is Y, the channel bandwidth is Z MHz, the sub-carrier spacing factor is μ, the carrier waveform is DFT-s-OFDM, the modulation mode is Pi/2 BPSK, and the RB allocation mode is edge RB allocation, then the second MPR in corresponding Table 2 is ≤×1 dB, or the second MPR is ×1 dB, or the second MPR offset value in corresponding Table 3 is Δ×1 dB. Wherein, the specific meanings and values of the transmission bandwidth, sub-carrier spacing, modulation mode, carrier waveform, power class, and RB allocation mode have been defined above, and will not be detailed here. Wherein, the definitions of edge RB, outer RB, inner RB, as well as area 1 and area 2 refer to the standard 3GPP TS38.101.

TABLE 2
Second MPR value corresponding to power class Y

| | | Second MPR (dB), Channel Bandwidth = | | | |
|---|---|---|---|---|---|
| | | Z MHz, and Sub-carrier spacing is μ. | | | |
| | | Edge RB | Outer RB | Inner RB Allocation | |
| Modulation Mode | | Allocation | Allocation | Area 1 | Area 2 |
| DFT-s- | Pi/2 BPSK | ≤x1 or x1 | ≤x2 or x2 | ≤x3 or x3 | ≤x4 or x4 |
| OFDM | QPSK | ≤x5 or x5 | ≤x6 or x6 | ≤x7 or x7 | ≤x8 or x8 |
| | 16 QAM | ≤x9 or x9 | ≤x 10 or x10 | ≤x11 or | ≤x12 or x12 |
| | | | | x11 | |
| | 64 QAM | ≤x13 or x13 | ≤x14 or x14 | ≤x15 or | ≤x16 or x16 |
| | | | | x15 | |
| | 256 QAM | ≤x17 or x17 | ≤x18 or x18 | ≤x19 or | ≤x20 or x20 |
| | | | | x19 | |
| | 1024 QAM | ≤x21 or x21 | ≤x22 or x22 | ≤x23 or | ≤x24 or x24 |
| | | | | x23 | |
| CP- | QPSK | ≤x25 or x25 | ≤x26 or x26 | ≤x27 or | ≤x28 or x28 |
| OFDM | | | | x27 | |
| | 16 QAM | ≤x29 or x29 | ≤x30 or x30 | ≤x31 or | ≤x32 or x32 |
| | | | | x31 | |
| | 64 QAM | ≤x33 or x33 | ≤x34 or x34 | ≤x35 or | ≤x36 or x36 |
| | | | | x35 | |
| | 256 QAM | ≤x37 or x37 | ≤x38 or x38 | ≤x39 or | ≤x40 or x40 |
| | | | | x39 | |
| | 1024 QAM | ≤x41 or x41 | ≤x42 or x42 | ≤x43 or | ≤x44 or x44 |
| | | | | x43 | |

TABLE 3
Second MPR offset value corresponding to power class Y

| | | Second MPR Offset Value (dB), | | | |
|---|---|---|---|---|---|
| | | Channel Bandwidth = Z MHz, | | | |
| | | and Sub-carrier spacing is μ. | | | |
| | | | | Inner RB | |
| | | Edge RB | Outer RB | Allocation | |
| Modulation Mode | | Allocation | Allocation | Area 1 | Area 2 |
| DFT-s- | Pi/2 BPSK | Δx1 | Δx2 | Δx3 | Δx4 |
| OFDM | QPSK | Δx5 | Δx6 | Δx7 | Δx8 |
| | 16 QAM | Δx9 | Δx10 | Δx11 | Δx12 |
| | 64 QAM | Δx13 | Δx14 | Δx15 | Δx16 |
| | 256 QAM | Δx17 | Δx18 | Δx19 | Δx20 |
| | 1024 QAM | Δx21 | Δx22 | Δx23 | Δx24 |
| CP- | QPSK | Δx25 | Δx26 | Δx27 | Δx28 |
| OFDM | 16 QAM | Δx29 | Δx30 | Δx31 | Δx32 |
| | 64 QAM | Δx33 | Δx34 | Δx35 | Δx36 |
| | 256 QAM | Δx37 | Δx38 | Δx39 | Δx40 |
| | 1024 QAM | Δx41 | Δx42 | Δx43 | Δx44 |

In various embodiments of the disclosure, a specific embodiment for UE performing calculation of signal transmission power based on the parameter related to MPR may be that: the UE obtains the second MPR value according to the determination conditions of the parameter related to MPR, and directly utilizes the MPR value to get involved in the calculation of transmission power.

In various embodiments of the disclosure, a specific embodiment for UE performing calculation of signal transmission power based on the parameter related to MPR may also be that: the UE obtains the second MPR offset value according to the determination conditions of the parameter related to MPR, and the UE determines the MPR value based on the second MPR offset value to get involved in the calculation of transmission power. Wherein, the specific calculation approach for the UE to obtain the MPR value is a difference between the first MPR value and the second MPR offset value, wherein the first MPR value is an MPR value obtained when the UE does not take the PAPR processing approach into consideration, and in particular, the first MPR value is an MPR value obtained when the TR technology is not adopted. At this time, the second MPR offset value is not lower than 0.

In various embodiments of the disclosure, the specific operations of the signal transmission method at least include one of or a combination of more than two of: the UE determines information of reserved tones and/or TR preparation time; the UE performs TR technology based on information of reserved tone and/or TR preparation time; the UE determines a power calculation parameter related to PAPR processing, and uses the power calculation parameter to calculate signal transmission power, and then transmits a signal. The power calculation parameter may be a parameter related to MPR. By using the signal transmission method, the UE can effectively reduce the PAPR of the time domain data signal and improve the transmission power of the signal, thereby improving the coverage and power efficiency.

In various embodiments of the disclosure, before the UE determines the information of reserved tones and/or the TR preparation time, the UE may report a first message to the first network node in advance, wherein the first message indicates whether the UE has a capability related to supporting PAPR processing. Specifically, the first message may be whether the UE has a capability related to supporting TR technology. One specific embodiment of the definition of the first message can be shown in Table 4.

TABLE 4
Definition of First Message

| | | | Different | Different |
|---|---|---|---|---|
| Parameter | | Mandatory | in FDD- | in FR1- |
| Definition | Per | Parameter | TDD | FR2 |
| The first message | UE/Band/ | No | Yes | Yes |
| indicates whether | Band | | | |
| to support a | Combination/ | | | |
| capability | Bandwidth | | | |
| related to TR | Part | | | |
| technology. | | | | |

As shown in Table 4, the first message may indicate whether the UE supports a capability related to TR technology. Specifically, the first message reported by the UE may be reported per UE, that is, the first message reported by the UE may be shared on all frequency bands. In addition, the first message reported by the UE may also be reported per frequency band and/or frequency band combination and/or bandwidth part, that is, the UE reports different first messages in different frequency bands and/or frequency band combinations and/or bandwidth parts, respectively. The UE may choose to report or not to report the first message, that is, this parameter is not a mandatory parameter to be reported. When the UE does not report the first message, the first message of the UE is a default value. The first messages reported by the UE in frequency division duplex (FDD) and time division duplex (TDD) may be different, that is, the UE reports different first messages in FDD and TDD modes. The UE reports different first messages in FR1 and FR2 frequency bands. For example, when the UE only supports the use of TR technology on FR2 frequency band and does not support the use of TR technology on FR1 frequency band, the UE reports different values of first messages in FR1 frequency band and FR2 frequency band, respectively.

One specific embodiment of the first message may be represented with 1 bit, in which 0 and 1 respectively represent that the UE does not have and does have a capability related to supporting TR technology. Specifically, 0 means having said capability, and 1 means not having said capability; or 1 means having said capability, and 0 means not having said capability.

The UE may obtain second information, wherein the second information indicates that the UE uses or does not use TR technology. One specific embodiment of this indication may be represented with 1 bit. 0 and 1 are used to indicate that UE does not use and does use TR technology, respectively. Specifically, 0 means using TR technology, and 1 means not using TR technology; or 1 means using TR technology, and 0 means not using TR technology. The second information may either be preset, or be obtained through a second message received from the first network node. The preset refers to a scenario where TR technology is used or not used by default according to specific application conditions. Wherein, the specific application conditions at least include one of the following information: transmission bandwidth, sub-carrier spacing, MCS, carrier waveform, power class and RB allocation mode. In a specific embodiment of the disclosure, whether to use TR technology is determined according to the specific values or specific embodiments of the transmission bandwidth and/or sub-carrier spacing and/or MCS and/or carrier waveform and/or power class and/or RB allocation mode. The receiving from the first network node means that the first network node configures whether the UE uses TR technology according to a specific application scenario, wherein the specific application scenario may be scheduling requirements in addition to the specific values or specific embodiments of the transmission bandwidth and/or sub-carrier spacing and/or MCS and/or carrier waveform and/or power class and/or RB allocation mode. Obtaining the second information by preset or obtaining it through the second message received from the first network node can realize a flexible use of TR technology in different situations.

In various embodiments of the disclosure, the first message reported by the UE may further include at least one of a class or a class parameter related to PAPR processing that can be supported by the UE, a class or a class parameter related to MPR that can be supported by the UE, a parameter related to PAPR processing that can be supported by the UE, and a parameter related to MPR that can be supported by the UE. The class parameter related to PAPR processing that can be supported by the UE is the degree of PAPR reduction that the UE can achieve when performing TR technology. The class parameter related to MPR that can be supported by the UE represent the degree to which the MPR can be reduced and further the degree to which the signal transmission power can be increased, when the UE performs TR technology. In various embodiments of the disclosure, the degree of PAPR reduction means the degree to which the PAPR can be reduced after the UE performs TR technology based on the TR technology parameter, which can be selected by the UE according to the class parameter related to PAPR processing. Wherein, the TR technology parameter refers to the parameter involved in performing operations related to TR, which may at least include information of reserved tones and/or TR preparation time, for example. The degree to which the signal transmission power can be increased indicates the degree to which the UE can increase the signal transmission power after performing TR technology, due to a reduction of PAPR, and a reduction of MPR value and an increase of output power of PA in a situation where the signal output quality is ensured. Wherein, the signal output quality may be given by error vector magnitude (EVM), for example. One specific embodiment of the definition of the class parameter related to PAPR processing and the class parameter related to MPR can be shown in Table 5 and Table 6.

TABLE 5
Definition of Class Parameter Related to PAPR Processing

| | | | Different | Different |
|---|---|---|---|---|
| | | | in FDD- | in |
| Parameter | | Mandatory | TDD | FR1- |
| Definition | Per | Parameter | modes | FR2 |
| The class parameter | UE/Band/ | No | Yes | Yes |
| related to PAPR | Band | | | |
| processing indicates | Combination/ | | | |
| the class parameter | Bandwidth | | | |
| value related to | Part | | | |
| PAPR processing | | | | |
| that can be | | | | |
| supported by the UE. | | | | |

TABLE 6
Definition of class parameter related to MPR

| | | | Different | |
|---|---|---|---|---|
| | | | in FDD- | Different |
| Parameter | | Mandatory | TDD | in FR1- |
| Definition | Per | Parameter | modes | FR2 |
| The class parameter | UE/ | No | Yes | Yes |
| related to MPR- | Band/Band | | | |
| related indicates the | Combination/ | | | |
| class parameter value | Bandwidth | | | |
| related to MPR that | Part | | | |
| can be supported by | | | | |
| the UE. | | | | |

As shown in Table 5 or Table 6, the class parameter related to PAPR processing or class parameter related to MPR indicates the class parameter value related to PAPR processing or class parameter value related to MPR that can be supported by the UE. Specifically, the class parameter value related to PAPR processing or class parameter value related to MPR reported by the UE may be reported per UE, that is, a set of class parameter values related to PAPR processing or class parameter values related to MPR reported by the UE may be shared on all frequency bands. Wherein, the set of class parameter values related to PAPR processing or class parameter values related to MPR indicates that there is at least one class parameter value related to PAPR processing or class parameter value related to MPR. In addition, the class parameter values related to PAPR processing or class parameter values related to MPR reported by the UE may also be reported per frequency band and/or frequency band combination and/or bandwidth part, that is, the UE reports different class parameter values related to PAPR processing or class parameter values related to MPR on different frequency bands and/or frequency band combinations and/or bandwidth parts, respectively. The UE may choose to report or not to report the class parameter value related to PAPR processing or class parameter value related to MPR, that is, the class parameter is not a mandatory parameter to be reported. When the UE does not report the class parameter value related to PAPR processing or class parameter value related to MPR, the class parameter value related to PAPR processing or class parameter value related to MPR of the UE is a default value. The class parameter values related to PAPR processing or class parameter values related to MPR reported by the UE differs between FDD and TDD, that is, the UE reports different class parameter values related to PAPR processing or class parameter values related to MPR in FDD and TDD. The UE reports different class parameter values related to PAPR processing or class parameter values related to MPR on FR1 frequency band and FR2 frequency band.

In various embodiments of the disclosure, the class parameter values related to PAPR processing reported by the UE may be one or more class parameter indexes related to PAPR processing that are supported by the UE. The class parameter values related to MPR reported by the UE may be one or more class parameter indexes related to MPR that are supported by the UE. The UE reports the class parameter values related to PAPR processing or class parameter values related to MPR, so as to facilitate the first network node to schedule according to the classes of capability in conjunction with specific application scenarios.

In various embodiments of the disclosure, when a class parameter value related to PAPR processing is the class parameter value related to specific PAPR processing, it means that the UE does not have a computing power for the PAPR processing at this time, that is, the UE does not adopt TR technology to reduce the PAPR of signal; when a class parameter related to PAPR processing is not the class parameter related to a specific PAPR processing, it means that the UE has a computing power of the PAPR processing at this time. When UE reports one class parameter value related to PAPR processing, the class parameter may represent the highest or lowest class parameter value related to PAPR processing that can be supported by the UE. At this time, the UE can support all other class parameter values related to PAPR processing not exceeding this class, or the UE can support class parameter values related to PAPR processing not lower than this class. When the UE reports one class parameter value related to PAPR processing, the parameter may also mean that the UE can only support the class parameter value with this class related to PAPR processing at this time. Optionally, the higher the class parameter related to PAPR processing reported by the UE is, the higher the degree of PAPR reduction that can be supported by the UE is, and further, the UE can use higher power for signal transmission, and vice versa. The different classes represented by the class parameters related to PAPR processing may be represented by numerical values, such as 0, 1, 2, and other integers, and may also be represented in other approaches that can distinguish different classes. In a specific embodiment of the disclosure, when the numerical value representing the class of the class parameter related to PAPR processing is higher, it means that the stronger of the PAPR reducing capability that can be supported by the UE at this time. Optionally, the class parameter value related to specific PAPR processing may be, for example, 0. Alternatively, the different classes represented by the class parameters related to PAPR processing may be represented by letters, such as A, B, C, and other letters. At this time, the class parameter value related to the specific PAPR processing can be A. Alternatively, the class parameters related to PAPR processing may also be represented in other suitable approaches that can distinguish different classes, as long as class 1, class 2 and so on can be distinguished. When the UE reports multiple class parameter values related to PAPR processing, it may mean that the UE can support the multiple class parameter values related to PAPR processing at this time. Such reporting approach of the UE can make the first network node give instructions in conjunction with specific application scenarios to facilitate signal transmission for UE, and can save signal overhead.

In various embodiments of the disclosure, the class parameter related to PAPR processing correspond to a group of parameter sets, and the parameter set includes at least one of the following parameters: PAPR reduction value or PAPR reduction range, proportion and/or number of reserved tones, positions of reserved tones, and TR preparation time. For a certain class parameter related to PAPR processing, there is a corresponding set of PAPR reduction values and/or proportion values of reserved tones and/or numbers of reserved tones and/or positions of reserved tones and/or TR preparation times. The UE determines the class parameter values related to PAPR processing and the corresponding parameter set based on at least one of the following information: MCS, transmission bandwidth, sub-carrier spacing, carrier waveform, power class and RB allocation mode. The MCS, especially the modulation mode corresponding to the MCS, identifies the EVM, that is, the signal output quality. The transmission bandwidth and sub-carrier spacing identity the number of frequency domain tones. In addition, the MCS, transmission bandwidth, carrier waveform, power class, RB allocation mode and the like all affect the signal transmission power. Because the purpose of reducing PAPR is to improve the signal transmission power while ensuring the signal output quality, the combination of information conditions will also affect the PAPR reducing capability. The UE reports the class parameter related to PAPR processing, and the first network node may perform parameter configuration for the UE according to the reported class.

Specifically, for a certain class of class parameter related to PAPR processing, a PAPR reduction value or PAPR reduction range represents a PAPR reduction amount that can be supported by the UE at this class, that is, a PAPR reduction level that can be supported by the UE. The greater this value is, the stronger the PAPR reducing capability of the UE after performing TR operation is.

For a certain class of class parameter related to PAPR processing, the proportion value of reserved tones represents a proportion of reserved tones among frequency domain tones at this class, that is, a proportion value of tones that can be used as reserved tones among given frequency domain tone resources to get involved in TR calculation when TR technology is being performed. The larger the proportion value is, the larger the number of reserved tones that get involved in TR calculation is under given frequency domain tone resources. It is worth noting that the number of reserved tones depends on the number of frequency domain tones and the proportion of reserved tones.

For a certain class of class parameter related to PAPR processing, the position of reserved tones refers to a specific position of the allocated reserved tone in given frequency domain tones. Since the position of reserved tone in frequency domain can affect the waveform in its time domain, it can affect the effect of peak cancellation of the time domain signal. The specific embodiment of the position of reserved tone may be a set of frequency domain tone position indexes under a corresponding position condition, and/or a tone index calculation formula. The position condition relates to at least one of the following parameters: transmission bandwidth, sub-carrier spacing, proportion of reserved tones or number of reserved tones, MCS, carrier waveform, power class and RB allocation mode. Wherein, the transmission bandwidth and sub-carrier spacing determine the number of frequency domain tones, and further, the number of frequency domain tones and the proportion of reserved tones determine the number of reserved tones.

For a certain class of class parameter related to PAPR processing, the TR preparation time represents a time required for performing TR technology corresponding to this class. The longer the time is, the longer the preparation time required for signal transmission is, and vice versa.

In various embodiments of the disclosure, there may be several groups of proportions of reserved tones and/or positions of reserved tone and/or TR preparation times corresponding to the same class parameter value related to PAPR processing and/or the same PAPR reduction range. For example, corresponding to a certain class parameter value related to PAPR processing, a larger proportion of reserved tones can be used over given spectrum resources, or more suitable positions of reserved tones can be selected over the given spectrum resources, so that TR operation can be completed in a shorter processing time. Such approach is applicable for scenarios with abundant spectrum resources and/or abundant UE memory resources and/or abundant UE operation processing units, and can enable UE to reduce PAPR in a shorter processing time, so as to realize low-latency communication. Corresponding to the same class parameter value related to PAPR processing, a smaller proportion of reserved tones can be used over given spectrum resources, or positions of reserved tones that are simply and easily operable can be allocated over the spectrum, but it is required to spend more processing time to complete the TR operation. Such approach is applicable for scenarios where spectrum resources are not abundant and/or UE memory resources are not abundant and/or UE operation processing units are not abundant, and a TR operation can be completed at the expense of more processing time.

In various embodiments of the disclosure, the parameters affecting the TR preparation time relate to at least one of operation speed of UE, operation time required to perform a single time-domain peak cancellation, a number of iterations of time-domain peak cancellation, and a threshold of time-domain peak cancellation. Wherein, the operation speed of UE identifies the operation time of basic operations of UE, the operation time required to perform a single time-domain peak cancellation and/or the number of iterations of time-domain peak cancellation identify the iterative operation time in TR technology, wherein the operation time required to perform a single time-domain peak cancellation is related to the memory size of UE and/or the number of operation processing units of UE. The larger the memory of UE and/or the number of operation processing units of UE is, the more memory and/or operation processing units the UE can use when performing a single time-domain peak cancellation operation, so as to process data in parallel and save operation time at the expense of resources. On the contrary, the UE can use less memory and/or operation processing units, so as to process data in series and save resources at the expense of time. In addition, the operation speed of UE also affects the operation time required to perform a single time-domain peak cancellation; the threshold of time-domain peak cancellation will affect the number of iterations and ultimately the processing time of TR technology.

In various embodiments of the disclosure, a specific embodiment of the class parameter related to PAPR processing may be that one class parameter value related to PAPR processing corresponds to a group of PAPR reduction values and/or proportions of reserved tones and/or numbers of reserved tones and/or positions of reserved tones and/or TR preparation times, as shown in Table 7. In Table 7, when the class parameter related to PAPR processing of UE is class 0, correspondingly, the PAPR reduction value is R0, the proportion of reserved tones is C0%, the position mode of reserved tones is P0, and the TR preparation time is TO; when the class parameter related to PAPR processing of UE is class 1, correspondingly, the PAPR reduction value is R1, the proportion of reserved tones is C1%, the position mode of reserved tones is P1, the TR preparation time is T1; and so on. When the class parameter related to PAPR processing is a specific class parameter related to PAPR processing, e.g., class 0, the PAPR reduction value is 0, the proportion of reserved tones is 0, the positions of reserved tones are null, and the TR preparation time is 0, that is, the UE does not support the use of TR operation at this time. The PAPR reduction values R0, R1, R2, or the like, may be 0 dB, 0.5 dB, 1 dB, or the like. The proportions of reserved tones C0%, C1%, C2% or the like, may be 0%, 1%, 2%, or the like. The positions of reserved tones P0, P1 and P2 correspond to different tone index sets and/or tone index calculation formulas. It is worth noting that each column in Table 7, such as PAPR reduction value, is optional.

TABLE 7
Class parameter related to PAPR processing and PAPR
reduction value, proportion of reserved tones,
position of reserved tone and TR preparation time.

| Class | | | | |
|---|---|---|---|---|
| Parameter | | Proportion | Position | |
| related to | PAPR | of | of | TR |
| PAPR | Reduction | Reserved | Reserved | Preparation |
| Processing | Value | Tones | Tone | Time |
| Class 0 | R0 | C0% | P0 | T0 |
| Class 1 | R1 | C1% | P1 | T1 |
| Class 2 | R2 | C2% | P2 | T2 |
| . . . | . . . | . . . | . . . | . . . |

In various embodiments of the disclosure, a specific embodiment of the class parameter related to PAPR processing may be that one/a common class parameter value related to PAPR processing corresponds to more than one group of proportions of reserved tones and/or numbers of reserved tones and/or positions of reserved tones and/or TR preparation times. This embodiment means that one PAPR reduction range can be implemented in various ways. At this time, the class parameter values related to PAPR processing may be further subdivided in terms of classes, so as to be used to correspond to a plurality of groups of the parameters. As shown in Table 8, when the class parameter related to PAPR processing is class Z, there may be different proportions of reserved tones and/or positions of reserved tones and/or TR preparation times for this class, thus classes Z0, Z1, . . . are further subdivided. For example, corresponding to class Z0, a combination of a proportion of reserved tones CZ0%, a position of reserved tone PZ0, and a TR preparation time TZ0 can be used to realize a PAPR reduction range for this class; corresponding to class Z1, a combination of a proportion of reserved tones CZ1%, a position of reserved tone PZ1, and a TR preparation time TZ1 can be used to realize a PAPR reduction range for this class; and so on. Specifically, TR technology can be performed by using a larger proportion of tones or selecting a more suitable position of reserved tone and a shorter TR preparation time, or by using a less proportion of tones or allocating a simply and easily operable position of reserved tone and a longer TR preparation time. Class parameters related to PAPR processing Z0, Z1, . . . all correspond to the same PAPR reducing capability, but use different time-domain or frequency-domain resource combinations.

TABLE 8
Corresponding proportion of reserved tones, position of
reserved tone and TR preparation time when class
parameter related to PAPR processing is class Z.

| Class Parameter | Proportion of | Position of | TR |
|---|---|---|---|
| related to PAPR | Reserved | Reserved | Preparation |
| Processing | Tones | Tone | Time |
| Class Z0 | CZ0% | PZ0 | TZ0 |
| Class Z1 | CZ1% | PZ1 | TZ1 |
| Class Z2 | CZ2% | PZ2 | TZ2 |
| . . . | . . . | . . . | . . . |

In various embodiments of the disclosure, the first message reported by the UE includes a class parameter related to MPR that can be supported. When the class parameter related to MPR is a specific class parameter value related to MPR, it means that the UE does not have MPR processing capability at this time; when the class parameter related to MPR is not a specific class parameter value related to MPR, it means that the UE can support the processing operations related to MPR at this time, so that the transmission power can be improved. When the UE reports a class parameter value related to MPR, the class parameter may represent the highest or lowest class parameter value related to MPR that can be supported by the UE. At this time, the UE can support all other class parameter values related to MPR not exceeding this class, or the UE can support class parameter values related to MPR not lower than this class. When the UE reports a class parameter value related to MPR, the parameter may also mean that the UE can only support the class parameter value related to MPR for this class at this time. Optionally, the higher the class of the class parameter related to MPR reported by the UE is, the higher the degree of the MPR reduction that can be supported by the UE is, and further, the UE can use higher power for signal transmission, and vice versa. The different classes represented by the class parameters related to MPR may be represented by numerical values, such as 0, 1, 2, and other integers, and may also be represented in other approaches that can distinguish different classes. In a specific embodiment of the disclosure, the higher the numerical value representing the class parameter related to MPR is, the stronger the MPR reducing capability that can be supported by the UE is at this time. Optionally, the specific class parameter value related to MPR may be, for example, 0. Alternatively, the different classes represented by the class parameters related to MPR may be represented by letters, such as A, B, C, and other letters. In this case, the specific class parameter value related to MPR may be A. Alternatively, the class parameters related to MPR may also be represented in other suitable approaches that can distinguish different classes, as long as class 1, class 2 and so on can be distinguished. When the UE reports multiple class parameter values related to MPR, it may mean that the UE can support the multiple class parameter values related to MPR at this time. Such reporting method of UE enable the first network node to give instructions in conjunction with specific application scenarios to facilitate signal transmission for UE, and can save signal overhead.

In various embodiments of the disclosure, the class parameter related to MPR corresponds to a certain class of parameter related to MPR, that is, a second MPR value and/or a second MPR offset value. The UE determines a class parameter value related to MPR and corresponding parameter based on a combination of information conditions. The combination of information conditions at least includes one of the following parameters: MCS, transmission bandwidth, sub-carrier spacing, carrier waveform, power class, RB allocation mode, class or class parameter related to PAPR processing, and parameter related to PAPR processing. Under different combinations of information conditions, the UE can correspondingly have different MPR improving capabilities. Under the same combination of information conditions, since TR technology can adopt different proportions and/or numbers and/or positions of reserved tones and/or TR preparation times, the corresponding MPR improving capabilities can also be different.

In various embodiments of the disclosure, a specific embodiment of the class parameter related to MPR may be that one class parameter value related to MPR correspond to one second MPR value and/or second MPR offset value. Based on the second MPR value and/or the second MPR offset value, the UE may calculate the transmission power of signal.

In various embodiments of the disclosure, the UE may obtain a third message from the first network node, wherein the third message includes at least one of: class parameter indication related to PAPR processing, class parameter indication related to MPR, parameter related to PAPR processing and parameter related to MPR. The method for UE to obtain the third message includes at least one of: obtaining the third message by analyzing a downlink control channel, obtaining the third message by analyzing high-layer signaling, and obtaining the third message by analyzing media access control information of a downlink shared channel. Optionally, the third message may be delivered through dynamic setting of downlink control information (DCI) or semi-static setting of RRC signaling. In various embodiments of the disclosure, when the UE has not received the third message from the first network node, the UE may adopt the preset values of class parameter related to PAPR processing and/or class parameter related to MPR, or may determine the parameter related to PAPR processing and class parameter related to MPR according to at least one of transmission bandwidth, sub-carrier spacing, MCS, carrier waveform, power class and RB allocation mode as described above, without determining according to class parameter related to PAPR processing and/or class parameter related to MPR. In various embodiments of the disclosure, the class parameter indication related to PAPR processing and/or class parameter indication related to MPR may be represented by integers, such as 0, 1, 2, or the like, or may also be represented in other approaches that can distinguish class 0, class 1, class 2, or the like, such as A, B, C, or the like.

In various embodiments of the disclosure, the second message and the third message received by the UE from the first network node may be the same message. For example, when the class parameter indication related to PAPR processing in the third message received by the UE from the first network node is a specific class parameter indication related to PAPR processing, and/or the class parameter indication related to MPR in the third message received by the UE from the first network node is a specific class parameter indication related to MPR, it means that the first network node notifies the UE not to use TR technology, when the class parameter indication related to PAPR processing in the third message received by the UE from the first network node is not the specific class parameter indication related to PAPR processing, and/or the class parameter indication related to MPR in the third message received by the UE from the first network node is not the specific class parameter indication related to MPR, it means that the first network node notifies the UE to use TR technology.

In various embodiments of the disclosure, the UE may receive a reconfigured third message transmitted from the first network node. This method is applicable for a situation where the application environment changes or the application requirements change, and the first network node dynamically adjusts the third message according to the change of the application environment or the application requirements.

In various embodiments of the disclosure, the UE may know the class parameter values related to PAPR processing indicated by the first network node according to the third message, and may correspondingly determine at least one of the following parameters according to the class parameter values related to PAPR processing PAPR reduction value or PAPR reduction range, proportion and/or number of reserved tones, position of reserved tones, and TR preparation time. Therefore, the information of reserved tones may be determined, so that uplink signal transmission may be performed based on the information of reserved tones. At the same time, the generation of uplink signals based on the information of reserved tones needs to satisfy the TR preparation time. The specific embodiment of the operation has been illustrated previously, and will not be detailed here.

In various embodiments of the disclosure, the UE may know the class parameter values related to MPR indicated by the first network node according to the third message, and according to the class parameter related to MPR, may correspondingly determine the second MPR value and/or the second MPR offset value, and calculate signal transmission power for transmission of uplink signal.

In various embodiments of the disclosure, the UE-side performs at least one of the following operations: the UE reports a first message to a first network node; the UE obtains a second message or second information and/or a third message, the UE reports a fourth message to the first network node, wherein the fourth message includes class parameter values related to PAPR processing and/or class parameter values related to MPR selected by the UE to get involved in calculation, or includes parameter related to PAPR processing or parameter related to MPR determined by the UE, the UE selects TR technology parameter to perform TR technology according to information related to PAPR processing included in the fourth message, the UE calculates signal transmission power according to information related to MPR included in the fourth message, and uses the power to transmit a signal to the first network node. Wherein, the selected class parameter related to PAPR processing and/or class parameter related to MPR included in the fourth message may be preset values, or may be determined according to the third message from the first network node, or may be class parameter related to PAPR processing and/or class parameter related to MPR that can be supported by the UE itself. Wherein, the signal transmission power is the transmission power of the signal after PAPR reduction by performing TR technology. In various embodiments of the disclosure, the transmission power is obtained by performing power back-off on the signal with reduced PAPR according to the second MPR value and/or the second MPR offset value obtained from the class parameter related to MPR. Different combinations of signaling interaction operations are applicable for different application scenarios.

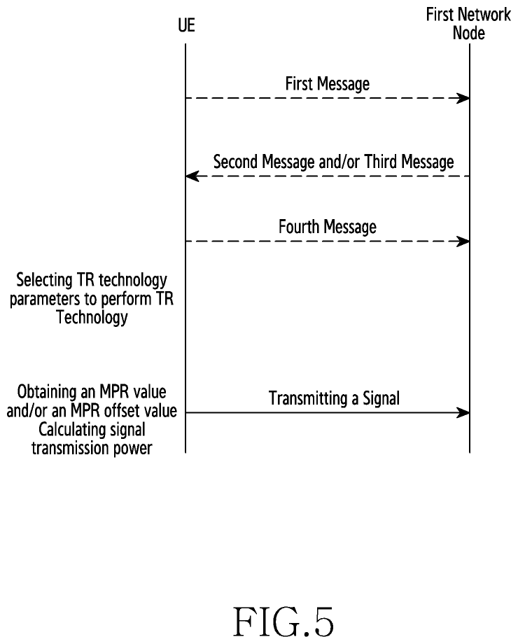

FIG. 5 illustrates a behavior at terminal side according to an embodiment of the disclosure.

Referring to FIG. 5, in various embodiments of the disclosure, a specific embodiment of the UE-side's behavior is shown in FIG. 5. Wherein,
Operation 1 (optional): the UE reports a first message to a first network node;
Operation 2 (optional): the UE obtains a second message or second information and/or receives a third message;
Operation 3 (optional): the UE reports a fourth message to the first network node;
Operation 4: the UE selects TR technology parameter according to the fourth message to perform TR technology;
Operation 5: the UE calculates transmission power according to a second MPR value and/or a second MPR offset value obtained from the fourth message, and uses the power to transmit a signal to the first network node.

Wherein, operation 3 and operation 4 can be exchanged in the order, without affecting the beneficial effects of the disclosure. In operation 3, the UE reports to the first network node class parameter related to the PAPR processing involved in calculation, in order to inform the first network node of the proportion and/or number and/or position of reserved tones, so as to facilitate the first network node to remove the reserved tones when extracting valid data information. More particularly, it is optional for the UE to report to the first network node the selected class parameter related to PAPR processing involved in calculation. When the UE has not reported the selected parameter to the first network node, the first network node knows by default the class parameter related to PAPR processing involved in calculation selected by the UE.

In a specific embodiment of the disclosure, when the UE has not obtained the third message from the first network node, the UE selects TR technology parameter to perform TR technology according to preset values of parameter related to PAPR processing and/or parameter related to MPR that can be included in the third message, so as to be applicable for scenarios where the UE and the first network node have default processing approaches about class parameter related to PAPR processing and/or class parameter related to MPR.

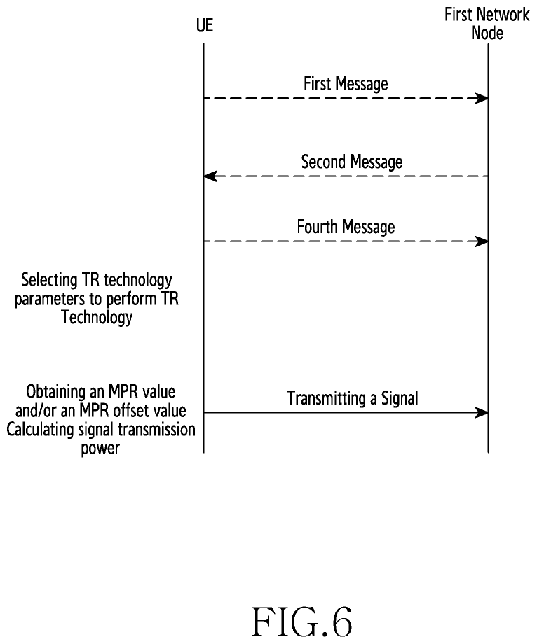

FIG. 6 illustrates a behavior at terminal side according to an embodiment of the disclosure.

Referring to FIG. 6, in an example, a specific embodiment of the UE-side's behavior is shown in FIG. 6. Wherein,
Operation 1 (optional): the UE reports a first message to a first network node;
Operation 2 (optional): the UE obtains second information, which is included in a second message in various embodiments;
Operation 3 (optional): the UE reports a fourth message to the first network node;
Operation 4: the UE selects TR technology parameter according to the fourth message to perform TR technology;
Operation 5: the UE calculates transmission power according to a second MPR value and/or a second MPR offset value obtained from the fourth message, and uses the power to transmit a signal to the first network node.

Wherein, operation 3 and operation 4 can be exchanged in the order, without affecting the beneficial effects of the disclosure. The scenario where the UE has not obtained the class parameter indication related to PAPR processing from the first network node may be a scenario where the first network node has not transmitted the class parameter indication related to PAPR processing to the UE, or a scenario where the first network node has transmitted the class parameter indication related to PAPR processing to the UE but the UE fails to obtain the parameter for some reason.

In a specific embodiment of the disclosure, when the UE reports the first message to the first network node and obtains the second message from the first network node, the UE selects TR technology parameter to perform TR technology according to the obtained class parameter indication related to PAPR processing, which is applicable for a situation in which the UE enables the first network node to know the capability of the UE for supporting the class parameter related to PAPR processing, so as to enable the first network node to select an applicable class parameter indication related to PAPR processing according to specific application scenarios. More particularly, if the UE obtains from the first network node a set of class parameter indications related to PAPR processing, the UE may use the highest or lowest class supported by the UE within the set of class parameter related to PAPR processing, so as to select TR technology parameter to perform TR technology.

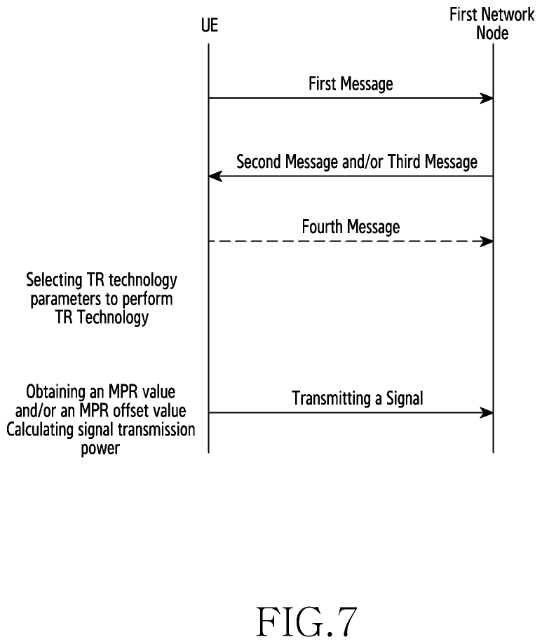

FIG. 7 illustrates a behavior at terminal side according to an embodiment of the disclosure.

Referring to FIG. 7, in an example, a specific embodiment of the UE-side's behavior is shown in FIG. 7. Wherein,
Operation 1: the UE reports a first message to a first network node;
Operation 2: the UE obtains a second message and/or a third message from the first network node;
Operation 3 (optional): the UE reports a fourth message to the first network node;
Operation 4: the UE selects TR technology parameter according to the fourth message to perform TR technology;
Operation 5: the UE calculates transmission power according to a second MPR value and/or a second MPR offset value obtained from the fourth message, and uses the power to transmit a signal to the first network node.

Wherein, operation 3 and operation 4 can be exchanged in the order, without affecting the beneficial effects of the disclosure.

In a specific embodiment of the disclosure, when the UE has not reported the first message to the first network node, but obtains the second message and/or the third message from the first network node, the UE selects the class parameter related to PAPR processing and/or class parameter related to MPR involved in calculation in conjunction with its own situation for the supporting of class parameter related to PAPR processing and/or class parameter related to MPR, selects TR technology parameter according to the class parameter related to PAPR processing to perform TR technology, and selects the second MPR value and/or the second MPR offset value according to the class parameter related to MPR to get involved in the calculation of transmission power. The specific approach for selecting is as follows: when the UE does not support the class parameter related to PAPR processing and/or class parameter related to MPR indicated by the first network node, the UE adopts the default class parameter related to PAPR processing and/or class parameter related to MPR; when the UE supports the class parameter related to PAPR processing and/or class parameter related to MPR indicated by the first network node, the UE adopts the class parameter related to PAPR processing and/or class parameter related to MPR obtained from the first network node. More particularly, if the UE obtains from the first network node a set of class parameter indications related to PAPR processing and/or class parameter indications related to MPR, the UE may use the highest or lowest class parameter supported by the UE in the class parameter indication related to PAPR processing.

In a specific embodiment of the disclosure, the UE may report its selected class parameter related to PAPR processing and/or class parameter related to MPR to the first network node, or may not report its selected class parameter related to PAPR processing and/or class parameter related to MPR to the first network node. Wherein, the UE reporting to the first network node its selected class parameter related to PAPR processing and/or class parameter related to MPR is applicable for a scenario where the first network node issues a group of class parameter indications related to PAPR processing and/or class parameter indications related to MPR, from which the UE selects one; or for a scenario where the UE does not support the class parameter related to PAPR processing and/or class parameter related to MPR indicated by the first network node, and the UE adopts the default class parameter related to PAPR processing and/or default class parameter related to MPR. More particularly, the default class parameter related to PAPR processing and/or default class parameter related to MPR adopted by the UE may be specific class parameter value related to PAPR processing and/or specific class parameter value related to MPR, that is, the UE does not adopt TR technology to reduce the PAPR of signal, or may be the highest or lowest class parameter related to PAPR processing and/or the highest or lowest class parameter related to MPR that can be supported by the UE itself. The situation in which the UE does not report its selected class parameter related to PAPR processing and/or class parameter related to MPR to the first network node is applicable for a scenario where the UE obtains a class parameter indication related to PAPR processing and/or class parameter indication related to MPR from the first network node, and the UE supports the class parameter related to PAPR processing and/or class parameter related to MPR, and the UE selects the class parameter related to PAPR processing and/or class parameter related to MPR to get involved in calculation.

This method is applicable for a scenario where the first network node gives an indication without knowing the capability of the UE for supporting of the class parameter related to PAPR processing and/or class parameter related to MPR, and the UE selects an appropriate class parameter related to PAPR processing and/or class parameter related to MPR according to its own capability in conjunction with the class parameter indication related to PAPR processing and/or class parameter indication related to MPR from the first network node.

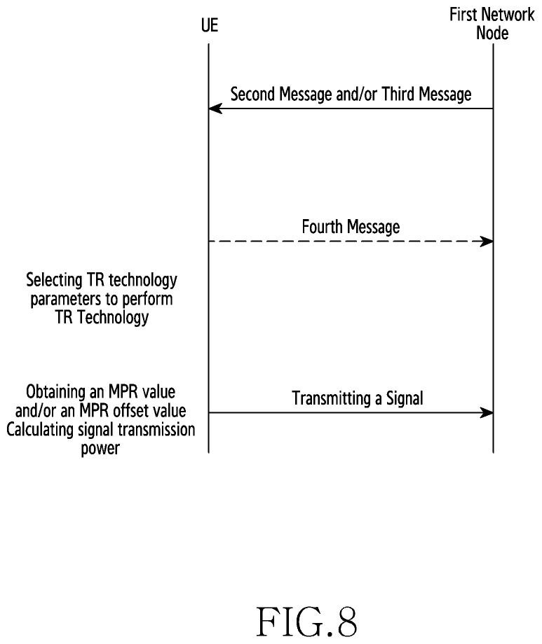

FIG. 8 illustrates a behavior at terminal side according to an embodiment of the disclosure.

Referring to FIG. 8, in an example, a specific embodiment of the UE-side's behavior is shown in FIG. 8. Wherein,
Operation 1: the UE obtains a second message and/or a third message from a first network node;
Operation 2 (optional): the UE reports a fourth message to the first network node;
Operation 3: the UE selects TR technology parameter according to the fourth message to perform TR technology;
Operation 4: the UE calculates transmission power according to a second MPR value and/or a second MPR offset value obtained from the fourth message, and uses the power to transmit a signal to the first network node.

In various embodiments of the disclosure, the approach for the UE to obtain the class parameter indication related to PAPR processing and/or class parameter indication related to MPR may be explicit or implicit. A specific embodiment of explicitly obtaining the class parameter indication related to PAPR processing and/or class parameter indication related to MPR may be that the UE directly obtains the indication. A specific embodiment of implicitly obtaining the class parameter indication related to PAPR processing and/or class parameter indication related to MPR may be that the UE obtains one of the two indications directly and then implicitly obtains another by means of the relationship between them. The UE implicitly obtains the unknown parameter indication by means of the correspondence between the class parameter indication related to PAPR processing and the class parameter indication related to MPR, which can save signaling overhead. The approach for the UE to directly obtain the class parameter indication related to PAPR processing and/or class parameter indication related to MPR may be to determine according to the class parameter indication related to PAPR processing and/or class parameter indication related to MPR received from the first network node, or the class parameter indication related to PAPR processing and/or class parameter indication related to MPR may be preset.

In various embodiments of the disclosure, a specific embodiment of the relationship between the class parameter indication related to PAPR processing and the class parameter indication related to MPR may be one-to-one, that is, one class parameter related to PAPR processing corresponds to one class parameter related to MPR. Such a one-to-one correspondence can obtain the unknown parameter indication when the UE obtains either of the class parameter indication related to PAPR processing and the class parameter indications related to MPR, which is simple and clear.

In various embodiments of the disclosure, a specific embodiment of the relationship between the class parameter indication related to PAPR processing and the class parameter indication related to MPR may also be multiple-to-one, that is, multiple PAPR reduction calculation class parameters correspond to one class parameter related to MPR. Such a multiple-to-one correspondence is applicable for a scenario where the UE obtains the class parameter related to MPR according to the implicit correspondence after obtaining the class parameter indication related to PAPR processing, that is, the MPR improvement effects achieved correspondingly by the multiple groups of TR technology parameters are consistent.

In various embodiments of the disclosure, a specific embodiment of the relationship between the class parameter indication related to PAPR processing and the class parameter indication related to MPR may also be one-to-multiple, that is, one class parameter related to PAPR processing corresponds to multiple class parameters related to MPR. Such a one-to-multiple correspondence is applicable for a scenario where the UE obtains the class parameter related to PAPR processing according to the implicit correspondence after obtaining the class parameter indication related to MPR, i.e., a scenario where multiple groups of class parameters related to MPR can be realized with the same group of TR technology parameters.

In various embodiments of the disclosure, the specific embodiment for the UE obtaining the class parameter indication related to PAPR processing and/or class parameter indication related to MPR through preset may be that the class parameter related to PAPR processing and/or class parameter indication related to MPR is given in association with a specific parameter set. The specific parameter set at least includes one of the following parameters: MCS, transmission bandwidth, sub-carrier spacing, carrier waveform, power class and RB allocation mode. Under a certain parameter set, the class parameter indication related to PAPR processing and/or the class parameter indication related to MPR may be determined correspondingly. In this way, the UE only needs to report the first message to inform the first network node whether the UE has a capability related to supporting TR technology, so that the first network node can determine the class parameter related to PAPR processing and/or class parameter related to MPR supported by the UE under the current specific parameter set, and the first network node transmits a second message to the UE to indicate the use of TR technology, so that the UE can determine the class parameter related to PAPR processing and/or class parameter related to MPR according to the current specific parameter set, get involved in TR operation and/or MPR value operation, and further, obtain transmission power and send out a signal. For example, for a specific group of parameter sets, the corresponding class parameter indication related to PAPR processing and/or class parameter indication related to MPR are determined. A specific embodiment for the UE obtaining the class parameter indication related to PAPR processing and/or the class parameter indication related to MPR through preset may be as shown in Table 9, wherein the modulation mode is determined by the MCS. When the power class is Y, the channel bandwidth is Z MHz, the sub-carrier spacing is μ, the carrier waveform is DFT-s-OFDM, the modulation mode is Pi/2 BPSK, and the RB allocation mode is edge RB allocation, then the class parameter indication related to PAPR processing and/or class parameter indication related to MPR is X1 class. Wherein, the specific meanings and values of the transmission bandwidth, sub-carrier spacing, modulation mode, carrier waveform, power class and RB allocation mode have been defined above, and will not be detailed here.

TABLE 9
Class parameter indication related to PAPR processing and/or class
parameter indication related to MPR with power class Y, channel
bandwidth = Z MHz and sub-carrier spacing μ

| | | Class parameter indication class related to | | | |
|---|---|---|---|---|---|
| | | PAPR processing or class parameter indication | | | |
| | | class related to MPR, channel bandwidth = | | | |
| | | Z MHz, and sub-carrier spacing is μ | | | |
| | | | | Inner RB | |
| | | Edge RB | Outer RB | allocation | |
| Modulation Mode | | Allocation | Allocation | Area 1 | Area 2 |
| DFT-s- | Pi/2 | X1 | X2 | X3 | X4 |
| OFDM | BPSK | | | | |
| | QPSK | X5 | X6 | X7 | X8 |
| | 16 QAM | X9 | X10 | X11 | X12 |
| | 64 QAM | X13 | X14 | X15 | X16 |
| | 256 QAM | X17 | X18 | X19 | X20 |
| | 1024 | X21 | X22 | X23 | X24 |
| | QAM | | | | |
| CP- | QPSK | X25 | X26 | X27 | X28 |
| OFDM | 16 QAM | X29 | X30 | X31 | X32 |
| | 64 QAM | X33 | X34 | X35 | X36 |
| | 256 QAM | X37 | X38 | X39 | X40 |
| | 1024 | X41 | X42 | X43 | X44 |
| | QAM | | | | |

Correspondingly, the behavior at the first network node side includes at least one of the following operations: the first network node receives a first message reported by a UE, the first network node transmits a second message and/or a third message to the UE, the first network node receives a fourth message, the first network node receives an uplink signal and ignores data on reserved tones.

It is worth noting that in the uplink signal transmission method in the disclosure, the definition and indication of class parameter related to PAPR processing, including specific parameter contents, such as PAPR reduction value, proportion or number of reserved tones, position of reserved tones, TR preparation time, or the like, and the corresponding specific embodiment of the disclosure, the conflict handling mechanism can all be applicable for downlink signal transmission.

It can be understood that although in the above description, the description is made taking a UE performing PAPR processing and transmitting an uplink signal as an example, the principle of the technology described in this way can also be applied to the situation in which a network node performs PAPR processing and transmits a downlink signal, or a relay node performs PAPR processing and transmits an uplink signal or downlink signal, through some adaptive changes. For example, in the case that the network node transmits a downlink signal through the above technology, the network node may transmit the used parameter related to PAPR processing and/or parameter related to MPR to the UE, and utilize the parameter related to PAPR processing and/or parameter related to MPR to process and transmit a downlink signal. Alternatively, the network node may also determine the parameter related to PAPR processing and/or parameter related to MPR to be used according to the configuration information related to PAPR of the UE that is to receive the signal, and utilize the parameter related to PAPR processing and/or parameter related to MPR to process and transmit the PAPR of downlink signal, wherein, for example, the configuration information, such as at least one of transmission bandwidth, sub-carrier spacing, modulation and coding scheme (MCS), carrier waveform, power class, resource block (RB) allocation mode, or the like, as mentioned above, can affect the PAPR of the transmitted signal of the UE.

On the other hand, according to an embodiment of the disclosure, there is proposed a downlink signal transmission method in a wireless communication system. In various embodiments of the disclosure, the behavior at the first network node side includes at least one of the following operations the first network node transmits a class parameter indication related to PAPR processing to a UE, the first network node performs TR technology to reduce PAPR of a transmitted signal, the first network node calculates transmission power and transmits a signal. Various alternative embodiments and corresponding embodiment details of the above various optional operations of the method are the same as or similar to the previously described embodiments of the disclosure, and will not be detailed here.

Correspondingly, the behavior at UE-side includes at least one of: the UE obtains a class parameter indication related to PAPR processing, wherein the approach for obtaining of the indication may be preset of the indication, or may be obtaining of the indication from the first network node, the UE receives a signal, and indicates to ignore data on reserved tones according to the class parameter related to PAPR processing. Various alternative embodiments and corresponding embodiment details of the above various optional operations of the method are the same as or similar to the previously described embodiments of the disclosure, and will not be detailed here.

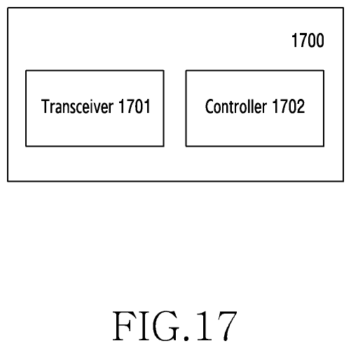

FIG. 17 illustrates a hardware block diagram of a communication device according to an embodiment of the disclosure.

Referring to FIG. 17, a communication device 1700 may include a transceiver 1701 and a controller 1702.

The transceiver 1701 may be configured to transmit and/or receive data and/or signals.

The controller 1702 may be an application specific integrated circuit or at least one processor. The controller 1702 may be configured to control the overall operation of the communication device and control the communication device to implement the method proposed in the embodiments of the disclosure. For example, in various embodiments of the disclosure, the communication device is a user equipment (UE) or a UE. For example, in another embodiment of the disclosure, the communication device is a network-side device, such as a first network node, a relay station and the like.

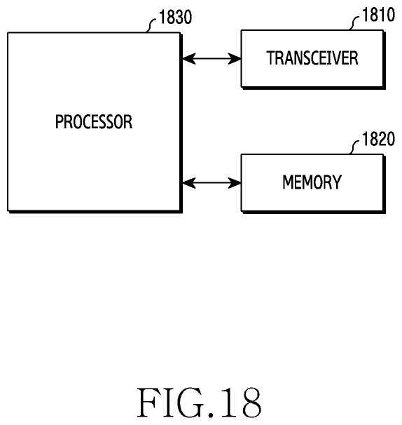

FIG. 18 illustrates a structure of a UE according to an embodiment of the disclosure.

Referring to FIG. 18, the UE according to an embodiment may include a transceiver 1810, memory 1820, and a processor 1830. The transceiver 1810, the memory 1820, and the processor 1830 of the UE may operate according to a communication method of the UE described above. However, the components of the UE are not limited thereto. For example, the UE may include more or fewer components than those described above. In addition, the processor 1830, the transceiver 1810, and the memory 1820 may be implemented as a single chip. In addition, the processor 1830 may include at least one processor. Furthermore, the UE of FIG. 18 corresponds to the UE of the FIG. 3 and the communication device of FIG. 17.

The transceiver 1810 collectively refers to a UE receiver and a UE transmitter, and may transmit/receive a signal to/from a base station or a network entity. The signal transmitted or received to or from the base station or a network entity may include control information and data. The transceiver 1810 may include a RF transmitter for up-converting and amplifying a frequency of a transmitted signal, and a RF receiver for amplifying low-noise and down-converting a frequency of a received signal. However, this is only an example of the transceiver 1810 and components of the transceiver 1810 are not limited to the RF transmitter and the RF receiver.

In addition, the transceiver 1810 may receive and output, to the processor 1830, a signal through a wireless channel, and transmit a signal output from the processor 1830 through the wireless channel.

The memory 1820 may store a program and data required for operations of the UE. In addition, the memory 1820 may store control information or data included in a signal obtained by the UE. The memory 1820 may be a storage medium, such as read-only memory (ROM), random access memory (RAM), a hard disk, compact disc read only memory (CD-ROM), and a digital versatile disc (DVD), or a combination of storage media.

The processor 1830 may control a series of processes such that the UE operates as described above. For example, the transceiver 1810 may receive a data signal including a control signal transmitted by the base station or the network entity, and the processor 1830 may determine a result of receiving the control signal and the data signal transmitted by the base station or the network entity.

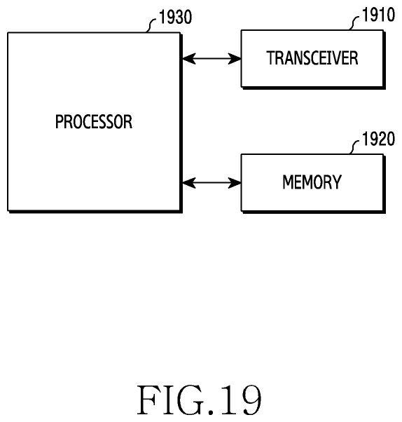

FIG. 19 illustrates a structure of a base station according to an embodiment of the disclosure.

Referring to FIG. 19, the base station according to an embodiment may include a transceiver 1910, memory 1920, and a processor 1930. The transceiver 1910, the memory 1920, and the processor 1930 of the base station may operate according to a communication method of the base station described above. However, the components of the base station are not limited thereto. For example, the base station may include more or fewer components than those described above. In addition, the processor 1930, the transceiver 1910, and the memory 1920 may be implemented as a single chip. In addition, the processor 1930 may include at least one processor. Furthermore, the base station of FIG. 19 corresponds to the base station of the FIG. 2 and the communication device of the FIG. 17.

The transceiver 1910 collectively refers to a base station receiver and a base station transmitter, and may transmit/receive a signal to/from a terminal (UE) or a network entity. The signal transmitted or received to or from the terminal or a network entity may include control information and data. The transceiver 1910 may include a RF transmitter for up-converting and amplifying a frequency of a transmitted signal, and a RF receiver for amplifying low-noise and down-converting a frequency of a received signal. However, this is only an example of the transceiver 1910 and components of the transceiver 1910 are not limited to the RF transmitter and the RF receiver.

In addition, the transceiver 1910 may receive and output, to the processor 1930, a signal through a wireless channel, and transmit a signal output from the processor 1930 through the wireless channel.

The memory 1920 may store a program and data required for operations of the base station. In addition, the memory 1920 may store control information or data included in a signal obtained by the base station. The memory 1920 may be a storage medium, such as read-only memory (ROM), random access memory (RAM), a hard disk, a CD-ROM, and a DVD, or a combination of storage media.

The processor 1930 may control a series of processes such that the base station operates as described above. For example, the transceiver 1910 may receive a data signal including a control signal transmitted by the terminal, and the processor 1930 may determine a result of receiving the control signal and the data signal transmitted by the terminal.

Those skilled in the art will understand that the illustrative embodiments described above are described herein and are not intended to be limiting. It should be understood that any two or more of the embodiments disclosed herein can be combined in any combination. In addition, other embodiments can be utilized and other changes can be made without departing from the spirit and scope of the subject matter presented herein. It will be readily understood that aspects of the disclosure, as generally described herein and shown in the accompanying drawings, can be arranged, substituted, combined, separated and designed in various different configurations, all of which are contemplated herein.

Those skilled in the art will understand that the various illustrative logical blocks, modules, circuits, and operations described in the application can be implemented as hardware, software, or a combination of both. In order to clearly illustrate this interchangeability between hardware and software, various illustrative components, blocks, modules, circuits, and operations are generally described above in the form of their function set. Whether such a function set is implemented as hardware or software depends on the specific application and the design constraints imposed on the overall system. Skilled people can implement the described function set in different ways for each specific application, but such design decisions should not be interpreted as causing a departure from the scope of the application.

The various illustrative logic blocks, modules, and circuits described in the application can be implemented in a general-purpose processor, a digital signal processor (DSP), an application specific integrated circuit (ASIC), a field programmable gate array (FPGA) or other programmable logic devices, discrete gate or transistor logic, discrete hardware component, or any combination thereof designed to perform the functions described herein. A general-purpose processor may be a microprocessor, but in the alternative, the processor may be any conventional processor, a controller, a microcontroller, or a state machine. A processor may also be implemented as a combination of computing devices, such as a combination of a DSP and a microprocessor, a plurality of microprocessors, one or more microprocessors cooperating with a DSP core, or any other such configuration.

The operation of the method or technique described in the application can be embodied directly in hardware, in a software module executed by a processor, or in a combination of both. Software modules may reside in RAM memory, flash memory, ROM memory, erasable programmable ROM (EPROM) memory, electrically EPROM (EEPROM) memory, register, hard disk, removable disk, or any other form of storage media known in the art. A storage medium is coupled to a processor to enable the processor to read and write information from/to the storage medium. In the alternative, the storage medium may be integrated into the processor. The processor and storage medium may reside in an ASIC. The ASIC may reside in the UE. In the alternative, the processor and the storage medium may reside in the UE as discrete components.

In one or more designs, the described functions can be implemented in hardware, software, firmware, or any combination thereof. If implemented in software, each function can be stored on or transferred by a computer-readable medium as one or more instructions or codes. Computer-readable media include both computer storage media and communication media, which includes any media that facilitates the transfer of computer programs from one place to another. The storage medium may be any available medium that can be accessed by a general-purpose or special-purpose computer.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
transmitting, to a first network node, a first message, wherein the first message indicates a UE capability related to peak-to-average power ratio (PAPR) or tone reservation (TR) technology;
receiving, from the first network node, a second message including information related to using TR technology;
identifying information associated with reserved tones based on the information related to using TR technology, wherein the information associated with reserved tones includes at least one of proportion, number, or position of reserved tones;
determining an uplink signal based on the information associated with reserved tones; and
transmitting, to the first network node, the uplink signal.

2. The method of claim 1, wherein the information associated with reserved tones is identified based on at least one of:
transmission bandwidth, sub-carrier spacing, modulation and coding scheme (MCS), carrier waveform, power class, or resource block (RB) allocation mode.

3. The method of claim 1, wherein the determining of the uplink signal is required to satisfy TR preparation time.

4. The method of claim 3, wherein the TR preparation time is related to at least one of:
transmission bandwidth, sub-carrier spacing, modulation and coding scheme (MCS), carrier waveform, power class, or RB allocation mode.

5. The method of claim 1, wherein transmission power of the uplink signal is determined based on a parameter related to maximum power reduction (MPR).

6. The method of claim 5, wherein the parameter related to MPR is determined based on at least one of:
transmission bandwidth, sub-carrier spacing, MCS, carrier waveform, power class, or RB allocation mode.

7. The method of claim 5,
wherein the parameter related to MPR includes at least one of:
a second MPR value, or
a second MPR offset value, and
wherein the second MPR value or the second MPR offset value are related to PAPR processing.

8. The method of claim 1, wherein the first message further comprises at least one of a class parameter related to PAPR processing or information on a parameter related to MPR.

9. The method of claim 1, further comprising:
receiving, from the first network node, a third message, wherein the third message includes at least one of:
class parameter indication related to PAPR processing,
class parameter indication related to MPR,
parameter indication related to PAPR processing, or
parameter indication related to MPR.

10. The method of claim 9, wherein the second message and the third message are same message.

11. The method of claim 9, further comprising:
receiving, from the first network node, a reconfigured third message.

12. The method of claim 9, further comprising:
identifying a class parameter related to PAPR processing based on the third message.

13. The method of claim 9, further comprising:
identifying a parameter related to MPR based on the third message, for uplink signal transmission.

14. A method performed by a first network node in a wireless communication system, the method comprising:
receiving, from a user equipment (UE), a first message, wherein the first message indicates a UE capability related to peak-to-average power ratio (PAPR) processing or tone reservation (TR) technology;
transmitting, to the UE, a second message including information related to using TR technology; and
receiving, from the UE, an uplink signal, wherein the uplink signal is identified based on information associated with reserved tones,
wherein the information associated with reserved tones includes at least one of proportion, number and position of reserved tones.

15. The method of claim 14, wherein power of the uplink signal is determined based on a parameter related to maximum power reduction (MPR).

16. The method of claim 15,
wherein the parameter related to MPR includes at least one of:
a second MPR value, or
a second MPR offset value, and
wherein the second MPR value or the second MPR offset value are related to PAPR processing.

17. The method of claim 14, wherein the first message further includes at least one of a class parameter related to PAPR processing or information on a parameter related to MPR.

18. The method of claim 14, further comprising:
transmitting, to the UE, a third message,
wherein the third message includes at least one of:
class parameter indication related to PAPR processing,
parameter indication related to MPR,
parameter indication related to PAPR processing, or
parameter indication related to MPR.

19. A user equipment (UE) comprising:
a transceiver; and
a controller coupled with the transceiver and configured to:
transmit, to a first network node, a first message, wherein the first message indicates a UE capability related to peak-to-average power ratio (PAPR) processing or tone reservation (TR) technology,
receive, from the first network, a second message including information related to using TR technology,
identify information associated with reserved tones based on the information related to using TR technology, wherein the information associated with reserved tones includes at least one of proportion, number, or position of reserved tones,
determine an uplink signal based on the information associated with reserved tones, and
transmit, to the first network node, the uplink signal.

20. A first network node comprising:
a transceiver; and
a controller coupled with the transceiver and configured to:
receive, from a user equipment (UE), a first message, wherein the first message indicates a UE capability related to peak-to-average power ratio (PAPR) processing or tone reservation (TR) technology,
transmit, to the UE, a second message including information related to using TR technology, and
receive, from the UE, an uplink signal, wherein the uplink signal is identified based on information associated with reserved tones,
wherein the information associated reserved tones includes at least one of proportion, number and position of reserved tones.
